(19) United States
(12) Patent Application Publication
(10) Pub. No.: US 2014/0161356 A1
(43) Pub. Date: Jun. 12, 2014

(54) MULTIMEDIA MESSAGE FROM TEXT BASED IMAGES INCLUDING EMOTICONS AND ACRONYMS

(71) Applicant: RAWLLIN INTERNATIONAL INC., Tortola (VG)

(72) Inventors: Måns Anders Tesch, Gard (FR); Johan Magnus Tesch, London (GB); Vsevolod Kuznetsov, Sankt-Petersburg (RU)

(73) Assignee: RAWLLIN INTERNATIONAL INC., Tortola (VG)

(21) Appl. No.: 13/710,352

(22) Filed: Dec. 10, 2012

(51) Int. Cl. G06K 9/48

(52) U.S. Cl. CPC G06K 9/48
USPC 382/196; 382/190

(57) ABSTRACT

Disclosed are systems, devices and techniques that generate a set of media portions associated with a set of message inputs for a multimedia message based on an emoticon or an acronym. A text based message can be received having an emoticon or acronym. The emoticon or acronym is identified in the text based message. A splicing component extracts a set of media content portions from media content, in which the media content portions correspond to the emoticon or acronym received. A multimedia message is generated with the media content portions to convey the text based message as a multimedia message.

### TECHNICAL FIELD

The subject application relates to media content and messages related to media content, and, in particular, to the composition of messages in association with emoticons and acronyms.

### BACKGROUND

Media content can includes various different forms of media and the contents that make up the different forms of media. For example, a film or video, also called a movie or motion picture, is a series of still or moving images that are rapidly put together and projected onto/from a display, such as by a reel on a projector device, or some other device, depending upon what generation a person is from. The video or film is produced by recording photographic images with cameras, or by creating images using animation techniques or visual effects. The process of filmmaking has developed into an art form and a large industry, which continues to provide entertainment to masses of people, especially during times of war or calamity.

Videos are made up of a series of individual images called frames, or also referred to herein as clips. When these images are shown rapidly in succession, a viewer has the illusion that motion is occurring. Videos and portions of videos can be thought of as cultural artifacts created by specific cultures, which reflect those cultures, and, in turn, affect them. Film is considered to be an important art form, a source of popular entertainment and a powerful method for educating or indoctrinating citizens. The visual elements of cinema give motion pictures a universal power of communication. Some films have become popular worldwide attractions by using dubbing or subtitles that translate the dialogue into the language of the viewer.

To these ends, people continue to express themselves in novel and different ways by leaving behind classical films that not only mark generations, but provide the shoulders for new generations to stand upon, subject to copyright laws. The above trends or deficiencies are merely intended to provide an overview of some conventional systems, and are not intended to be exhaustive. Other problems with conventional systems and corresponding benefits of the various non-limiting embodiments described herein may become further apparent upon review of the following description.

### SUMMARY

The following presents a simplified summary in order to provide a basic understanding of some aspects disclosed herein. This summary is not an extensive overview. It is intended to neither identify key or critical elements nor delineate the scope of the aspects disclosed. Its sole purpose is to present some concepts in a simplified form as a prelude to the more detailed description that is presented later.

Various embodiments for evaluating and communicating media content and media content portions corresponding to a set of inputs are contained herein. An exemplary system comprises a memory that stores computer-executable components and a processor, communicatively coupled to the memory, which facilitates execution of the computer-executable components. The computer-executable components comprise a text component configured to receive a text message having an emoticon or an acronym for generation of a multimedia message. An image analysis component is configured to identify the emoticon or the acronym in the text message. A media splicing component is configured to extract a set of media content portions from media content that correspond to the emoticon or the acronym. The computer-executable components include a message component configured to generate the multimedia message with the set of media content portions.

In another non-limiting embodiment, an exemplary method comprises receiving, by a system including at least one processor receiving, by a system including at least one processor, a text message having an emoticon or an acronym for generation of a multimedia message. The method includes identifying the emoticon or the acronym in text message with an image represented by the emoticon or a set of words represented by the acronym. A set of media content portions is extracted from media content that correspond to the emoticon or the acronym according to a first set of predetermined criteria. The multimedia message is generated with the set of media content portions.

In yet another non-limiting embodiment, an example apparatus comprises a memory storing computer-executable instructions, and a processor, communicatively coupled to the memory, that facilitates execution of the computer-executable instructions to at least receive an emoticon or an acronym in a set of text messages for generation of a multimedia message, identify a set of media content portions from video content based on the emoticon or the acronym, and generate the multimedia message with the set of media content portions having at least one video image or audio content corresponding to the emoticon or the acronym.
In still another non-limiting embodiment, an exemplary computer readable storage medium comprising computer executable instructions that, in response to execution, cause a computing system including at least one processor to perform operations. The operations comprise receiving an emoticon or an acronym for generating a multimedia message. For the emoticon or the acronym, a set of media content portions is determined that corresponds to the emoticon or the acronym based on a set of predetermined criteria. The multimedia message is generated with the set of media content portions that correspond to the received emoticon or the received acronym.

In another example embodiment, a system comprises means for receiving a set of message inputs having at least one of an emoticon or an acronym for a multimedia message, means for identifying a set of media content portions of a set of media content that correspond to the emoticon or the acronym, and means for generating the multimedia message with the set of media content portions that correspond to the emoticon or the acronym.

The following description and the annexed drawings set forth in detail certain illustrative aspects of the disclosed subject matter. These aspects are indicative, however, of but a few of the various ways in which the principles of the various innovations may be employed. The disclosed subject matter is intended to include all such aspects and their equivalents. Other advantages and distinctive features of the disclosed subject matter will become apparent from the following detailed description of the various innovations when considered in conjunction with the drawings.

### BRIEF DESCRIPTION OF DRAWINGS

Non-limiting and non-exhaustive embodiments of the subject disclosure are described with reference to the following figures, wherein like reference numerals refer to like parts throughout the various views unless otherwise specified.

FIG. 1 illustrates an example messaging system in accordance with various aspects described herein;

FIG. 2 illustrates another example messaging system in accordance with various aspects described herein;

FIG. 3 illustrates another example messaging system in accordance with various aspects described herein;

FIG. 4 illustrates an example set of acronyms and corresponding meanings in accordance with various aspects described herein;

FIG. 5 illustrates an example set of emoticons and corresponding meanings in accordance with various aspects described herein;

FIG. 6 illustrates an example of a flow diagram showing an exemplary non-limiting implementation for a messaging system for evaluating media content in accordance with various aspects described herein;

FIG. 7 illustrates another example of a flow diagram showing an exemplary non-limiting implementation for a messaging system for evaluating media content in accordance with various aspects described herein;

FIG. 8 illustrates an example system in accordance with various aspects described herein;

FIG. 9 illustrates another example system in accordance with various aspects described herein;

FIG. 10 illustrates another example system in accordance with various aspects described herein;

FIG. 11-13 illustrate an example view pane in accordance with various aspects described herein;

FIG. 14 illustrates an example of a flow diagram showing an exemplary non-limiting implementation for a recommendation system for evaluating media content in accordance with various aspects described herein;

FIG. 15 illustrates another example of a flow diagram showing an exemplary non-limiting implementation for a recommendation system for evaluating media content in accordance with various aspects described herein;

FIG. 16 illustrates an example system in accordance with various aspects described herein;

FIG. 17 illustrates another example system in accordance with various aspects described herein;

FIG. 18 illustrates another example view pane of a slide reel in accordance with various aspects described herein;

FIG. 19 illustrates another example message component in accordance with various aspects described herein;

FIG. 20 illustrates an example media component in accordance with various aspects described herein;

FIG. 21 illustrates an example view pane in accordance with various aspects described herein;

FIG. 22 illustrates an example of a flow diagram showing an exemplary non-limiting implementation for a recommendation system for evaluating media content in accordance with various aspects described herein;

FIG. 23 illustrates another example of a flow diagram showing an exemplary non-limiting implementation for a recommendation system for evaluating media content in accordance with various aspects described herein;

FIG. 24 illustrates an example system in accordance with various aspects described herein;

FIG. 25 illustrates another example system in accordance with various aspects described herein;

FIG. 26 illustrates another example system in accordance with various aspects described herein;

FIG. 27 illustrates another example system in accordance with various aspects described herein;

FIG. 28 illustrates an example system flow diagram in accordance with various aspects described herein;

FIG. 29 illustrates another example of a flow diagram showing an exemplary non-limiting implementation for a system for generating a multimedia message in accordance with various aspects described herein;

FIG. 30 illustrates another example of a flow diagram showing an exemplary non-limiting implementation for a system for generating multimedia message in accordance with various aspects described herein;

FIG. 31 is a block diagram representing exemplary non-limiting networked environments in which various non-limiting embodiments described herein can be implemented; and

FIG. 32 is a block diagram representing an exemplary non-limiting computing system or operating environment in which one or more aspects of various non-limiting embodiments described herein can be implemented.

### DETAILED DESCRIPTION

Embodiments and examples are described below with reference to the drawings, wherein like reference numerals are used to refer to like elements throughout. In the following description, for purposes of explanation, numerous specific details in the form of examples are set forth in order to provide a thorough understanding of the various embodiments. It will be evident, however, that these specific details are not necessary to the practice of such embodiments. In other instances, well-known structures and devices are shown in block diagram form in order to facilitate description of the various embodiments.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon such as with a module, for example. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements. The word “set” is also intended to mean “one or more.”

In consideration of the above-described trends or deficiencies among other things, various embodiments are provided that generate a message for a user that includes a sequence of media clips or media content portions. The media content portions can include, for example, portions of videos from movies having audio content and/or imagery. A message component of a system having a processor and a memory generates the message that comprises a multi-media message, or a message having multiple different media contents having a sequence of media clips or media content portions. The message is generated in response to a set of message inputs being received, such as a text based message from a mobile device. The message inputs received can include emoticons and/or acronyms (e.g., :) or LOL), which are used in text based messages via a Short Message Service (SMS), for example.

In response to receiving images from a user device, the personal data store, and/or other similar mechanism, an image analysis component is configured to identify the emoticon or the acronym in the text message and in a set of media content portions from media content. The media content portions can include a portion, a segment, and/or a clip of a movie and/or an audio content (e.g., song, speech, and the like), as well as images and photos. The message is then assembled together as a sequence of clips with audio and/or video content that corresponds (correlates) to the message inputs received having an emoticon or an acronym.

The media content portions have at least one digital image from the images provided, for example, and can be determined based on a set of user preferences/classification criteria and/or according to a set of predetermined criteria. The multi-media message can then be assembled based on further inputs (e.g., a text based message received) or on the message inputs received with the emoticon or acronym. The multimedia message can then be communicated via a computer device, such as a mobile phone, a network and/or some other system to provide a more expressive message that embodies video and audio content dynamically generated according to a user's taste and personality. A user is further able to modify the set of corresponding media content portions to correspond to different emoticons and/or acronyms to replace media content portions generated as initially corresponding to an emoticon or acronym.

The words “portion,” “segment,” “scene,” “clip”, and “track” are used interchangeably herein to indicate a section of video and/or audio content that is generally meant to indicate less than the entirety of the video or audio recording, but can also include the entirety of a video or audio recording, and/or image, for example. Additionally, these words, as used herein can have the same meaning, such as to indicate a piece of media content. A scene generally indicates a portion of a video or a segment of a video, for example, however, this can also apply to a song or audio content for purposes herein to indicate a portion or a piece of an audio bite or sound recording, which may or may not be integral to or accompany a video.

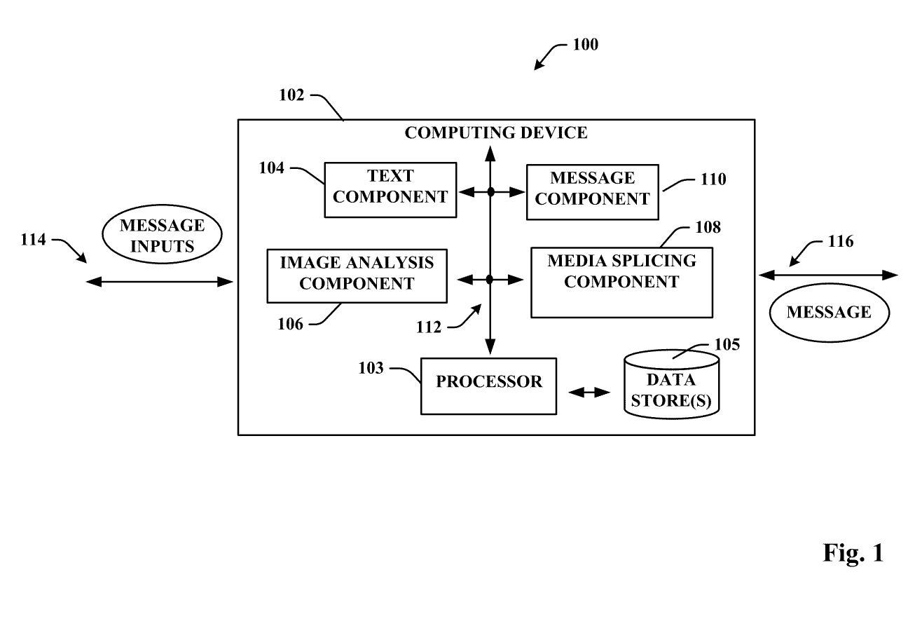

Referring initially to FIG. 1, illustrated is an example system for generating multimedia messages in accordance with various embodiments disclosed. The system 100 operates to receive a set of message inputs including an emoticon and/or an acronym and process the emoticon and/or acronym into a multimedia message as a personalized message comprising media content portions (e.g., video/image/audio content segments) to then communicate to a recipient device. The system 100 includes a computing device 102, which can include a mobile device, a smart phone, a laptop, personal digital assistant, personal computer, mobile phone and a hand held device, digital assistant and like devices, for example. The computing device includes at least on processor 103 for processing computer executable instructions, which is communicatively coupled to one or more data stores 105 that store the computer executable instructions for executing one or more components. The computing device 102 includes a text component 104, an image analysis component 104, a media splicing component 108 and a message component 110 that operate to generate multimedia messages comprising one format and content from message inputs that can have a different format and content.

For example, the text component 104 is configured to receive a set of message inputs 114 that can include a text message having an emoticon or an acronym for generation of a multimedia message. The text component 104 is operable to communicate the emoticon or acronym to the image analysis component 106 via a communication bus, line or connection 112, which can include any communication pathway. For example, message inputs 114 can include various text based messages having numerical, alphabetic, alphanumeric, and the like typed characters or symbols to convey a message within. The text component 104 operates to identify emoticons or acronyms within the text based message of the message inputs for further processing. The message inputs can also include other types of content and is not limited to only text based content as detailed infra.

In one embodiment, the text component 104 is configured to identify an emoticon and an acronym within a set of message inputs 114. An emoticon includes a pictorial representation of a facial expression using punctuation marks and letters, which can be written or typed to express a person's mood or to convey an image. Emoticons are often used to alert a responder to the tenor or temper of a statement, and can change and improve interpretation of plain text; emoticons for a smiley face :-) and sad face :-( appear in the first documented use in digital form. The word is a portmanteau word of the English words emotion and icon. In web forums, instant messengers and online games, text emoticons are often automatically replaced with small corresponding images, which came to be called emoticons as well.

In addition or alternatively, the text component 104 operates to receive and identify an acronym of the message inputs 114. For example, an acronym includes a text message shorthand and/or a chat acronym that is used to convey a message. For example, a text message can include the acronym “LOL,” which can be received as a text message shorthand for “Laughing Out Loud” and is intended to convey that something is funny or funny enough to cause someone the sender to laugh out loud. Many other examples exist, some of which are detailed further below. In another example, acronyms intend to provide an abbreviation for names or words that in the traditional sense are formed to shorten words that are long according to the first letter of one or more words. For example, a shorthand designation of the acronym United States of America is USA.

The text component 104 operates to receive any kind of acronym, whether a chat acronym and/or an acronym intended for abbreviating a person, place or thing and an emoticon that is replaced with a corresponding image or one that is purely text based. The text component 104 is coupled to the image analysis component 106 that is configured to perform an analysis on the message input 114 and to identify emoticons and acronyms within a text based message. In one embodiment, a table or index of different emoticons and acronyms with their corresponding meaning or image can be stored in the data store 114 for reference. The image analysis component 106 operates to look up the index or table and based on the features of the text message identify acronyms and/or emoticons in a message inputted to the system. In one embodiment, the index/tables can be updated manually by a user to designate acronyms and/or emoticons to a specific meaning, image, emotion and the like. In addition or alternatively, the image analysis component 106 is operable to dynamically discern an emoticon or acronym's meaning with a network connection and/or via expert system or fuzzy logic processes.

For example, the image analysis component 106 can communicate a search query over a network connection that generates various meanings, definitions, and/or interpretations of an acronym and/or an emoticon received by the text component 104. Each of the results can be stored in the data store 105 in an index or table entry that associates the emoticon or acronym with a result. In addition or alternatively, a user can enter the meaning (e.g., an image, emotion, words or phrases, etc.) manually so that as future acronyms or emoticons are received in a message for or by the particular user, the image analysis component 106 associates the meaning to the emoticon or acronym. In another embodiment, a set of classifications can be associated with the emoticon or acronym in order for the image analysis component to discern what images, emotions, words or phrases could be associated with the particular emoticons or acronym.

In yet another embodiment, the system 100 includes the media splicing component 108, or otherwise a media clipping component in communication with the other components via the communication bus 112. The media splicing component 108 is configured to extract a set of media content portions from media content that correspond to the emoticon and/or the acronym received in the message input 114. In one embodiment, the media splicing component is further configured to extract the set of media content portions from the media content according to a set of predetermined criteria and/or from the set of classifications discussed above. The set of predetermined criteria, for example, can include at least one of a matching of audio content of the media content with words that are represented by the acronym or the matching of an action, an expression, or audio content with an image or an emotion represented by the emoticon. A set of classification criteria can include, for example, least one of a set of themes selected to correspond with the set of media content, a set of song artists selected to correspond with the set of media content, a set of actors selected to correspond with the set of media content, a set of album titles selected to correspond with the set of media content, a set of media ratings of the set of media content, a voice tone selected to correspond with the set of media content, a time period selected to correspond with the set of media content or a personal media content preference selected to correspond with the set of media content from a personal video or audio stored in the data store 105, in addition to other classifying characteristics set of by a user or defined further by user preferences.

The media content that is spliced by the media splicing component 108 includes at least one of video content having audio content, video content, audio content, or an image, from cinematic movie content that includes a film featured in a public theatre, in which the image can be a drawn, or digitally created image or photo. The media splicing component 108 receives the identified emoticons and/or acronyms from the image analysis component 106, and according to the predetermined criteria and/or the set of classifications, as well as user preferences operates to portions, splice or extract portions of media from the set of media content.

For example, the media splicing component 108 can received identification of a smiley face in the set of message inputs 114 from the image analysis component 106. The message input 114, for example, could be a colon with a closed parenthesis (e.g., :)), as an acronym could be LOL as an example. In response to identification of the emoticon and/or acronym, the media splicing component 108 operates to generate portions of media from media content stored in the data store 105 or another data store for video/image/audio content, and/or a network connection having a data store such as a cloud network. The portions of media content or media content portions include segments of video clips and/or images that express the emoticon and/or acronym. For example, a smiley face identified in a text message as the message input could initiate the media splicing component 108 to generate any number of portions of a movie, film or other video, audio content, photos or the like as candidate to place within the multimedia message for the portion of the multimedia message that corresponds to or is expressed by the emoticon received. The same is true for acronyms, such as LOL. As such, inputs are received/entered into the system 100 as text based inputs (e.g., from a text message) and a multimedia message is generate with video portions, image portions, audio portions, etc. from different types of movies, films, videos, audio, photos, etc. that are linked to and analyzed by the image analyzing component 106 and extracted according to the media splicing component 108.

The media splicing component 108 can operate to splice media content according to the set of predetermined criteria and/or the set of classifications as discussed above. For example, a user or client of the system 100 can set the classifications according to a set of selections for a rating, a date, an event, a genre or theme, an actor, a person, etc. for the media content or media content portions from the media content to be analyzed and spliced. In response to a Halloween setting for the theme or date selection and the smiley face emoticon (:)) and/or LOL acronym, for example, the media splicing component 108 returns media content portions having a smiley face made by a vampire, werewolf, jack-o-lantern, ghost, or any other hallowed like theme with images, videos segments, or sounds having the Halloween theme and that also correspond to the emoticon a smiley face. For example, a smiley face or LOL received as message input and a Halloween theme entered for the classification criteria, the media splicing component 108 could return a vampire smiling or laughing out loud from scenes of the movie “Salem's Lot” based on the novel written by Stephen King. This is only one example of many different classifications that can be set and which are detailed throughout this disclosure for the generation of a multimedia message in response to message input (e.g., text based messages), for example. Other themes could be a Christmas theme, an Easter bunny theme, and the like.

In another embodiment, a plurality of classification criteria can also be set in conjunction with one another. For example, while a Christmas theme is selected or entered, a person or character can also be set to be Rudolph, so that an entered text message having LOL or a smiley face generates a portion of a video having Rudolph laughing. Other classifications can also be set as well as other emoticons and acronyms for analysis and the generation of one or more multimedia messages comprising media content portions associated with a text.

The message component 110 is configured to generate the multimedia message with the set of media content portions that correspond to the emoticon or the acronym of the set of text messages. The message component 110 can assemble the media content portions according to the emoticon or icon based on the sequence in which the emoticon or acronym is received in the text message and/or based on a different order defined in the set of classifications or a set of user preferences.

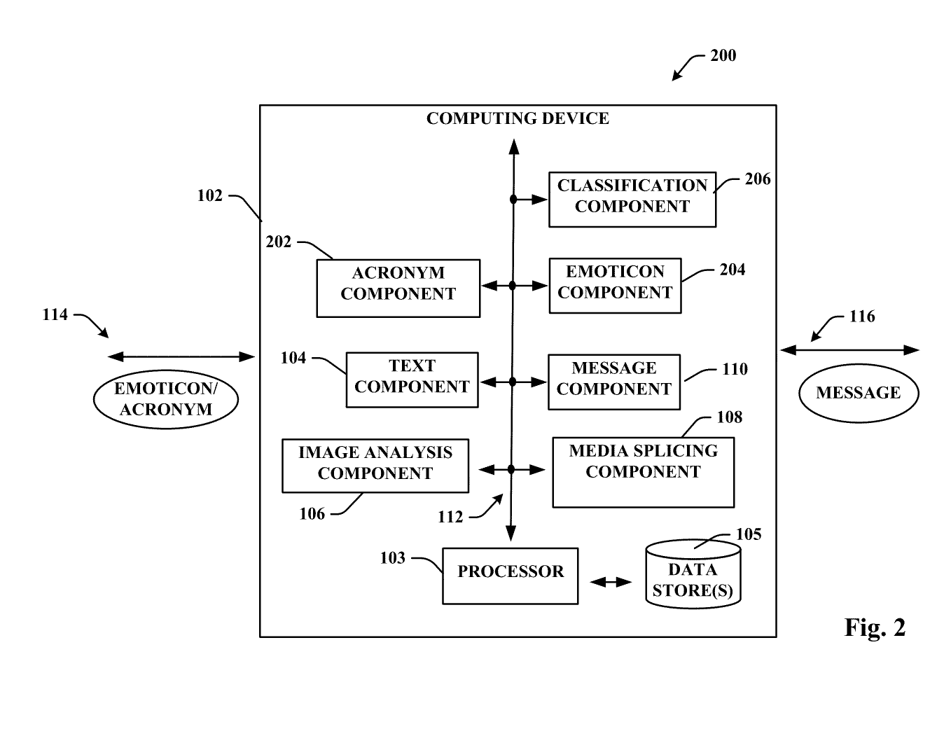

Referring now to FIG. 2, illustrated is an example system 200 for generating multimedia messages in accordance with various embodiments disclosed. The system 200, with similar components as discussed herein, includes an acronym component 202, and emoticon component 204 and a classification component 206.

The acronym component 202 is configured to identify words represented by the acronym of a text message that is received by the system 200. The acronym component 202 can identify and then correlated any number of acronyms with any number of words or phrases according to an interpretive assessment of the acronym. For example, an acronym can be determined to convey a message as well as an abbreviation of a person, place, thing, action, emotion, etc. As such, the acronym component 202 associates (correlates) words or phrases that may not be literally translated in the acronym, but can interpret meaning, emotions, a message and the like with the acronym by associating one or more words (or phrases) with an acronym. This can be a dynamic association in which no predefined associations in an index or table are provided, and also in cases where predefined associations are stored or communicated to the acronym component 202 multiple meanings or interpretations can be provided so that various different words or phrases are associated with the acronym received.

For example, a chat acronym could be received by the system such as “182,” in which multiple meanings could be determined from this number. The number can be just a number, in which according to a matching audio content, the image analysis component 106 and the media splicing component 108 of the system identify video content having audio (media content portions) with the words “one hundred eighty two.” In addition or alternatively, media content portions having the words “I hate you,” could also be generated. Therefore, a segment of the movie, “Sleepless in Seattle” could be generated with an actor or actress saying, “I hate you,” in order to comprise at least a portion of the multimedia message. Additionally, if the set of classifications has Meg Ryan selected or entered to be the actress in the media content portions, the portion of the video in which Meg Ryan's role informs Tom Hanks “I hate you,” can be generated as an option for expressing the acronym “182.” As such, the acronym component 202 can associate various words to “182” of the text based message to words such as “one hundred and eighty two” as well as “I hate you” for corresponding different media content portions associated with the words or phrase.

The emoticon component 204 is configured to identify an image and/or a sound represented by the emoticon expressed in a text message or other message input and correspond the image to a textual word or phrase for further processing or analysis. The emoticon component 204 correlates (associates) an interpretive meaning to the image received in a text message for media content portions to be generated in a multimedia message. In one embodiment, words or phrases are associated with the image identified and then the media content is searched and spliced for video segments, audio segments, and/or image content portions that represent the words or phrases. Various interpretations can be ascertained from an emoticon, such as a sad feeling, disapproval, pouting, etc. from a single image. The emoticon component 204 is operable to identify an interpretive meaning with words or phrases in order for the media splicing component to parse segments of media content.

For example, a sad face can be associated with the word sad. In response, to the correlation of the word “sad,” settings set for the classification criteria and any predetermined criteria being satisfied and/or user preferences for the associated words or phrases, the media splicing component 108 can splice segments of media content expressing sadness, vocalizing the word sad, and/or acting in sad manner, for example.

In another embodiment, the acronym component 202 and the emoticon component 204 can enable manual modification or editing of the words or phrases correlated with a particular acronym or emotion, which can be set according to a set of user preferences for the acronym and emoticon components 202, 204. For example, a word associated with an image of a bunny rabbit illustrated via a text based image of a text message could be “soft,” “fluffy,” “bunny,” “rabbit” and/or another descriptor. A user could decide to modify the correlation of the image to something he or she and a friend would only understand the meaning to be, (e.g., the word “cute”) or something others would not necessarily realize immediately. In addition or alternative, a user could narrow the focus of the meaning to just fluffy, or broaden the focus to include fluffy with a color (e.g., grey), with a different animal, etc. Regardless of the word or phrase, the correlation is able to be modified via a user setting or preference via the emoticon component 204. A modification alters the associations of the acronym component and the emoticon component to generate different associations among an acronym and/or an emoticon with an image of media content.

The classification component 206 is configured to receive a set of classification options for the set of classifications in order to set criteria by which components of the system 200 generate multimedia messages. The set of classifications include at least one of a set of themes selected to correspond with the set of media content, a set of song artists selected to correspond with the set of media content, a set of actors selected to correspond with the set of media content, a set of titles (albums titles, movie titles, book titles, song titles, etc.) selected to correspond with the set of media content, a set of media ratings of the set of media content, a voice tone selected to correspond with the set of media content, a time period selected to correspond with the set of media content and/or a personal media content preference selected to correspond with the set of media content from a personal video or audio stored in a data store.

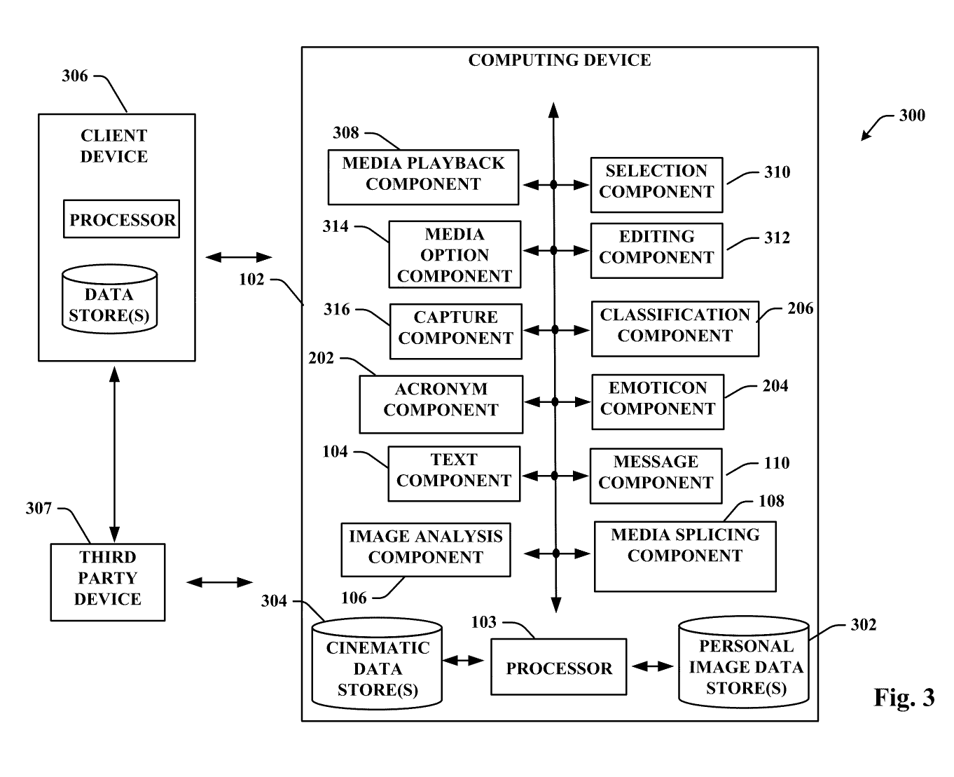

Referring now to FIG. 3, illustrated is a system 300 in accordance with various embodiments disclosed. The computer device 102 further includes similar components as discussed above and further includes a media playback component 308, a selection component 310, an editing component 312, a media option component 314, and a capture component 316.

The system 300 includes a personal image data store 302 that can include a repository of acronyms and/or emoticons for storing personal home videos and images created on the computing device 102 and/or a different client device 306, and/or third party device 307 (e.g., a server, or other device), for example. The system 300 further includes a cinematic data store 304 for storing cinematic videos or images that have been viewed or presented in a public theatre, for example, that may have been licensed or purchased. Either data store 302 or 304 can also include media content (video/audio/images) from a third party device 307 for generating a repository of videos, which can be provided on a cloud network, at the computing device 102, the third party device/server 307, another client device 306 and/or the like, in which the body of media content that has been processed by the various components described herein can be presented on a social network and/or other professional or family network.

The media playback component 308 is configured to generate a preview of the multimedia message that includes generating a word or phrase and/or the at least one video or image sequentially according to a message inputs having an emoticon and/or acronym received. In addition, the media playback component 308 can generate a preview of a selected media content portion or segment of media content that is stored in the data store 302 and/or 304, which enables viewing and/or editing of the multimedia message.

The selection component 310 is configured to receive a selection that identifies a media content portion with an emoticon and/or acronym. For example, the media content portions that are correlated with an emoticon and/or acronym can be modified by a user to have a different emoticon and/or acronym associated with a media content portion. For example, a video segment or portion having a smiley or happy face associated with it, can be edited to have a different word associated with it, such as “happy” and “smile”, and then further edited to replace as well as add additional words associated with the particular media content portions, such as “laugh” or any acronym associated with the word. In one embodiment, the labeled emoticon or acronym associated with the media content portion can be presented with the media content portion generated within the multimedia message. In this way, the multimedia message includes textual labels (an emoticon and/or acronym) connected to a media content portion, which is included in the multimedia message conveying a new or different text message for the user to send.

The editing component 312 is configured to edit emoticons and/or acronyms associated with the set of media content portions according to a set of user preferences, which can include a user preference for a number of words to connect with the portions (one or more images), a set of descriptors for each portions (e.g., colors, events, words spoken, sounds, music, date, etc.), a set of verbs, a set of nouns, a set of names, a set of places, a set of metadata, and the like) so that the words or phrases connected with each portion from the set of home videos or personal photos are indicative of the user's preferences for labeling with an emoticon and/or acronym. For example, a portion of video may be labeled according to the word or phrase “red ball,” “moving,” “rolling,” “on green grass,” and also the word “catch,” which could have been spoken or identified to be within the video, and also with emoticons and/or acronyms. A user preference can be set to label the portions within the video according to a person's name, an object identified (ball), a color illustrated, and from any other characteristic illustrated or spoken in the media content, along with a particular emotion, image, word or phrase associated with emoticons and/or acronyms. A set of user preferences for one set of video/audio/image content can be designated for nouns, colors, places, etc. while a different set of user preferences for correlating words or phrases can be designated to a different set of video/audio/image content. This enables a user to input various different types of videos or images and guide the analysis and correlation of various types of media content for configuring multimedia messages. As such, when the user generates a multimedia message by typing a phrase or text based message (message inputs) with emoticons and/or acronyms, the system can correspond certain words or phrases in the message inputs with particular words or phrases connected to different sets of media content stored based on the user preferences for each. Nouns, for example, can be connected to a video of a dog filmed, and verbs could be connected to a different film of a home video of a birthday party, for example. Upon assembling or generating the multimedia message, each set of videos could be analyzed for determined media content portions as options for the user to select. The user therefore, enters a text based message of a text based format and the system outputs a video/image/audio/multimedia message of a different format for viewing and conveying a dynamic text message.

The media option component 314 is configured to generate the set of media content portions generated from emoticons and/or acronyms in a personal data store of home videos/images/audio and/or a set of cinematic media content portions generated from a set of cinematic movie content as options for a correlation with the emoticons and/or acronyms based on a selected option, whereby the set of cinematic movie content is stored in a data store and comprises content of a film that was featured in a public theatre. The media option component 206 provides options for a user to select from, in which portions of media content from different sets of videos (e.g., home video and cinematic video) can be provided in the multimedia message. A user, for example, could prefer a scene from a movie (e.g., Rocky) to represent a an emoticon and/or acronym, rather than a segment of a home video. Both portions can be presented to the user in order for the user to correlate certain emoticons and/or acronyms with. The capture component 316 are respectively configured to capture videos and/or photos in order to generate the image content, in which media content portions are generated from for a multimedia message. For example, rather than receiving the set of images from an external data store, or the data store 105, the images and videos can be directly captured for the user to generate a video stream of video/audio/images automatically based on text or message inputs entered or received by the system 300.

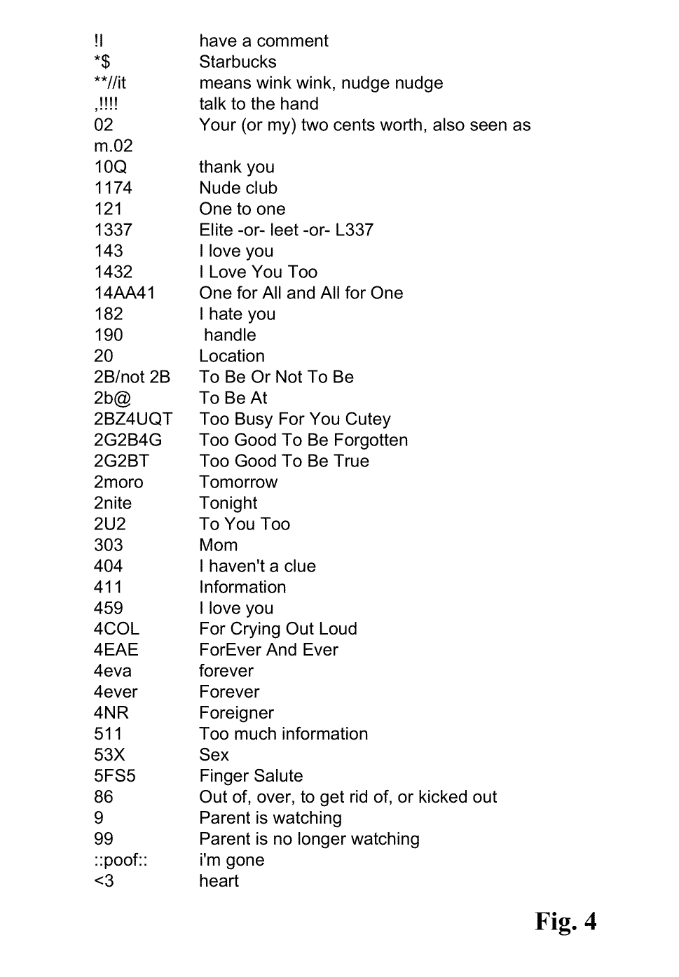

Referring now to FIG. 4, illustrated is a set of acronyms from a text based messages in accordance with embodiments disclosed herein. The acronyms and their meanings are not exhaustive and are an example of acronyms and meanings associated with them for identifying further media content portions of each as they are received. A text based message, a selection input, a modification input, a preselected input, and/or other type of inputs can be received having a text based message “4eva,” which has the same meaning as “forever.” Media content portions are then found that include the word or depict a meaning of “forever” in video/image/audio content of the media content portions. The image analysis component and the media splicing components described herein can implement definitions of acronyms and emoticon through an index table, and/or a network lookup or search, for example in order to then store the acronyms and meanings.

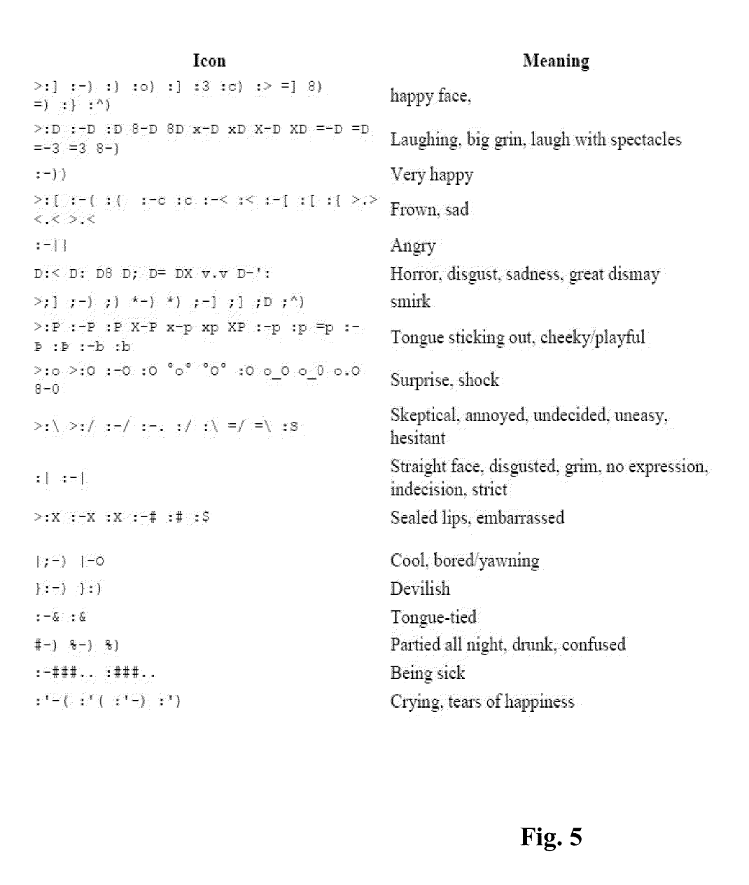

Referring now to FIG. 5, illustrates an example of emoticons listed as an icon and an associated meanings in accordance with aspects described in this disclosure. The example set of text based images, text based icons, or, in other words, set of emoticons is not exhaustive and many other emoticons and associated meanings are envisioned.

While the methods described within this disclosure are illustrated in and described herein as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the description herein. Further, one or more of the acts depicted herein may be carried out in one or more separate acts and/or phases. Reference may be made to the figures described above for ease of description. However, the methods are not limited to any particular embodiment or example provided within this disclosure and can be applied to any of the systems disclosed herein.

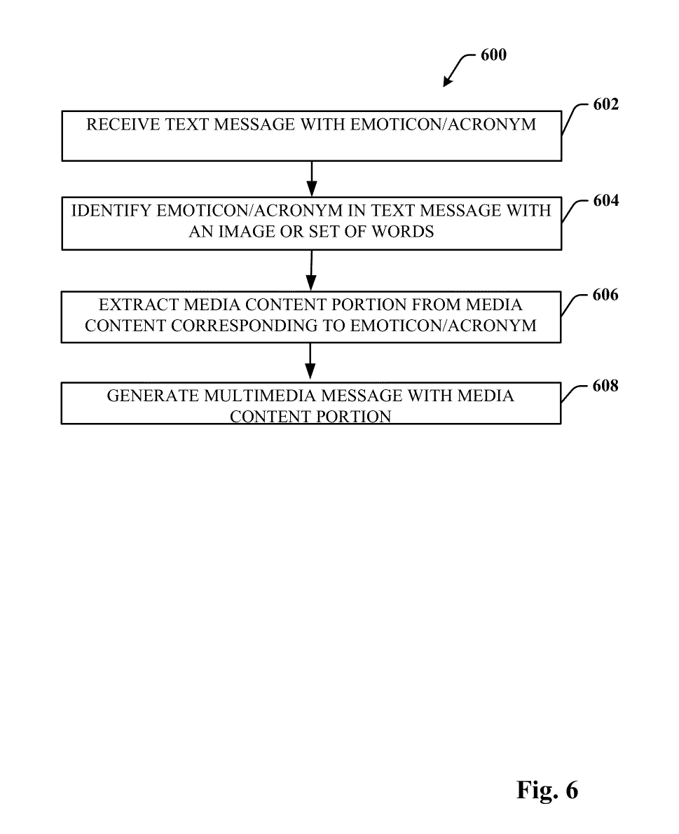

Referring to FIG. 6, illustrates a method 600 for a messaging system in accordance with various embodiments disclosed herein. The method 600 initiates and at 602, the method includes receiving, by a system including at least one processor, an emoticon and/or an acronym via a text based message, a selection input for a predefined emoticon/acronym selection, and or other communicated input. At 604, an emoticon and/or an acronym can be identified with an image or a set of words. For example, the emoticon and/or acronym in a text message can be associated with a particular image and/or words in order to connect a meaning for the portion of the text message having the emoticon/acronym. At 606, one or more media content portions are extracted from media content corresponding to the emoticon and/or acronym. The media content portions can be video/image/audio content that are identified and/or extract according to a set of predetermined criteria. For example, a match of the image and/or audio content with the identified word/phrase/image of the emoticon and/or acronym can determine what portions are extracted from the media content stored in a data store. In one embodiment, the multimedia message can include at least one video or image from the set of media content portions generated from the set of image content and also corresponds to at least one word or phrase of the set of message inputs as part of the multimedia message, which is in addition to the emoticon and/or acronym of the message. For example, the multimedia message can partially comprise text, such as in a text message and then also include portions of video that convey the remainder of the message. The video portions can be from different videos (different movies, films, personal videos, personal photos, audio, etc.). The multimedia message can include at least one video or image from the set of media content portions generated from the set of image content (personal content), at least one textual word or phrase received in the set of message inputs and audio content that corresponds with at least one portion of the set of message inputs

At 608, a multimedia message is generated with the media content portion(s) that correspond to the image and/or words identified with the emoticon/acronym. For example, a meaning of the emoticon/acronym can be identified and used based on words or images to identify the media content portions that are included in the message. Various user inputs and selection for classifications and other predetermined criteria, such as matching of an expression, an action, an event, along with other criteria discussed herein can focus the extracting of the media content portions and generation of the multimedia message.

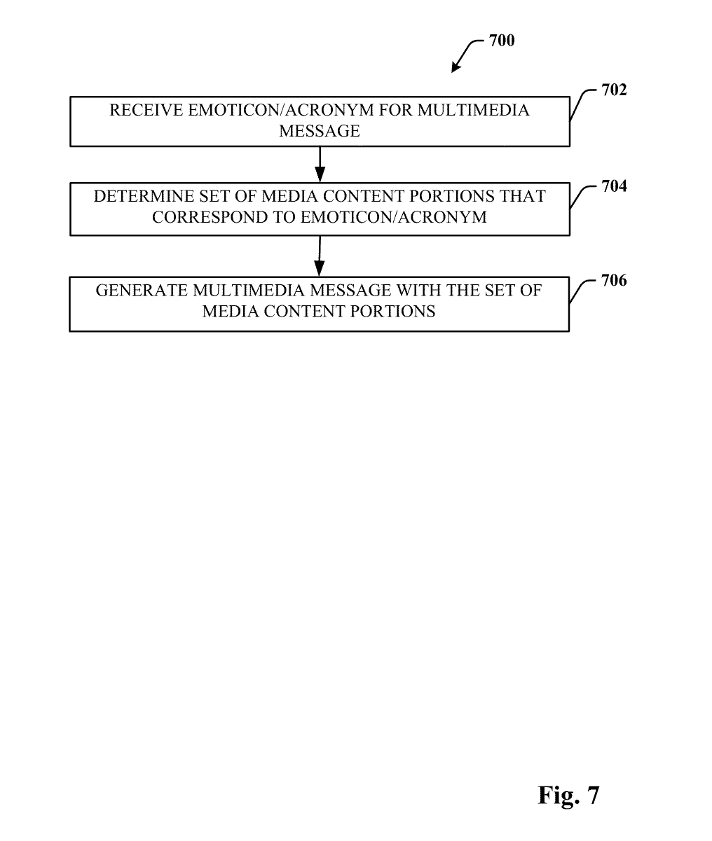

An example methodology 700 for implementing a method for a system for media content is illustrated in FIG. 7. The method 700, for example, provides for a system to evaluate various media content inputs and generate a sequence of media content portions that correspond to words, phrases or images of the inputs.

At 702, the method initiates with receiving one or more emoticons and/or acronyms for generating a multimedia message. The emoticons and/or acronyms can be received from text message, a predefined selection, as a query term or the like, for example.

At 704, the method includes determining a set of media content portions including content that corresponds to the emoticon and/or acronym. In one embodiment, the association or corresponding can be done with a word, a phrase or an image to interpret the meaning of the emoticon and/or acronym. The word, phrase or image can then be associated audio content, which can be associated with segments of video or not, in order to determined portions of video corresponding to the emoticon and/or acronym. Other criteria can also be used to determine media content portions from media content that correspond to the emoticon and/or acronym received. For example, a matching action, expression, event, etc. can be used to determine portions of media content that correspond with the intended message of an emoticon and/or acronym. The emoticon and/or acronym can then be conveyed via a multimedia message that is generated at 706, such as via a mobile device, a mobile phone, and/or any other computer device.

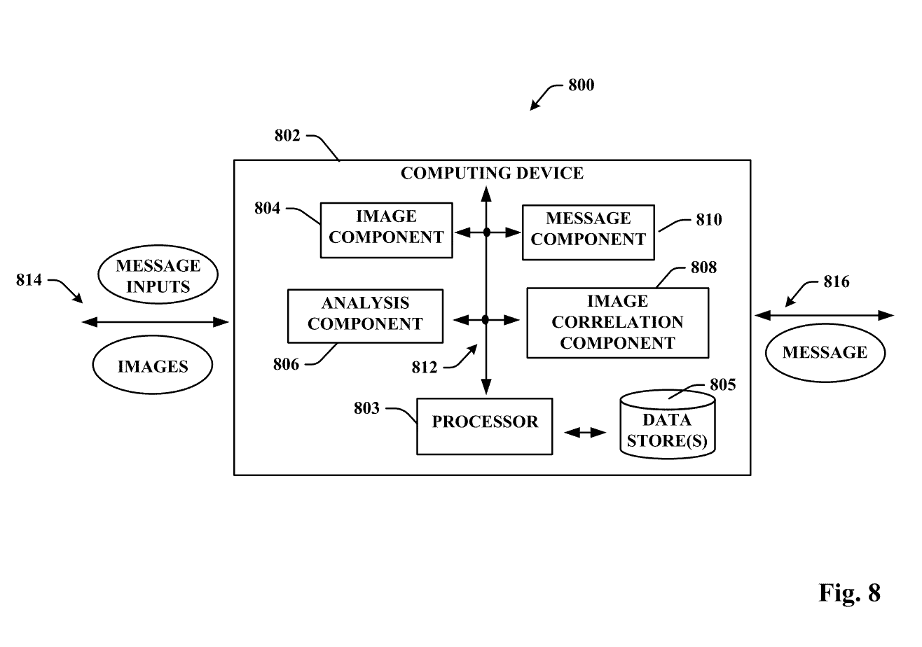

Referring to FIG. 8, illustrated is an example system for generating multimedia messages in accordance with various embodiments disclosed. The system 800 operates to receive a set of images such as videos, pictures, created drawings, as well as audio accompanying the set of images for storage in one or more data stores. The set of images are analyzed to identify portions or segments of the images according to a set of predetermined criteria. The portions are then tagged, labeled, or, in other words, correlated to a word or phrase in order to be further identified. Based on a message or a set of message inputs received by the system 800, a different message is generated with the identified portions to convey the same intended message.

The system 800 comprises a computing device 802 that receives inputs and generates a message that can be communicated. A user is able to utilize the system 800 to input home videos captured or other images with or without audio content and further generate a multimedia message 886 from the inputted home videos or other images. The computing device 802 can be any computing device, such as a mobile device, laptop, personal digital assistant, personal computer, mobile phone and the like. The computing device 802 operates to receive a set of inputs comprising a set of images 814. The set of images 814 can include videos, pictures, created/drawn images, and the like, which can also include audio content associated with or separate to the set of images 814. Additionally or alternatively, the computing device 802 can receive the set of inputs 814 as message inputs for the computing device to generate a message 816 that comprises portions of the set of images 814.

The computing device 802 comprises at least one processor 803 that is communicatively coupled to one or more data store(s) 805 having computer executable instructions for executing one or more components. The computing device 802 further comprises an image component 804, an analysis component 806, an image correlation component 808, and a message component 810. The components of the computing device 802, the processor 803 and the data store(s) 805 are communicatively coupled to on another via a communication link 812. The communication link 812 can include any communication link including a wired connection, wireless connection, optical connection, and other similar connections for communication, in which the system is not limited to any single type of communication architecture or mechanism.

The image component 804 is configured to receive a set of images stored in a personal video or personal image data store for generating a multimedia message. The personal data store can be the data store 805, an external data store of a client device or other computing device, and/or an additional data store of the system 800 that stores personal data such as image content including videos, photos, and/or any digital media content that is designated by or inputted from a user. In other embodiments, as discussed infra, media content can also be stored from third party server or system, which is inputted to the system 800 via a different communication channel or connection than just between the system and a client device user, for example.

An image analysis component 806 is configured to determine a set of media content portions from the set of images. The image analysis component 806, for example, analyzes video content, image content, and/or audio content to determine portions or segments that can be used in a message according to a set of predetermined criteria and/or a set of classification criteria. For example, the image analysis component 806 can identify portions of the set of images stored in the data store 805 and/or received via the set of inputs 814 (e.g., personal home videos, photos, drawings, etc.). The set of predetermined criteria can include identification of one or more images with a particular facial expression, an action, an event occurring, audio content (spoken or not) characteristics about any occurrences in the video, a time frame of events, and/or a manual selection or splicing of the image content to include one or more scenes or images, for example. The set of classification criteria can include a theme or genre identified, a voice tone, a section of audio associated with the images (e.g., a time period), a time period corresponding to a historical time period or a range of dates, according to actors or actresses identified, a language spoken, a defined user preference matching a device in which the image(s) were captured, as well as any metadata associated with the set of images received by the system via a communication pathway or a data store. The image analysis component 806 therefore operates to analyze the set of media content such as image content with video and/or audio content to determine portions of media content (one or more scenes or digital images) to be used for generating multimedia messages s they a correspond with a set of message inputs.

The image correlation component 808 is configured to correlate a set of metadata such as words or phrases with the set of media content portions that have been determined from the set of images 814. The image correlation component 808, for example, tags the identified media content portions with data such as a word or phrase. The set of predetermined criteria described above can be used by the image correlation component 808 to connect the portions identified in the set of image content 814 with words or phrases. Each word or phrase, for example, can be any tag, label or metadata that identifies the media content portion to the system, the client device or for a user selection. For example, the word “RUN” can be connected to portion of a home video of a relative running for a specified or particular duration. This portion of video could have been identified by the image analysis component 806 based on the person, the time, the action occurring, the duration of the action, etc. Therefore, when a user inputs a set of message inputs having the word “RUN” to be included in a multimedia message 816, such as by the inputs 814, the system 800 operates to recognize the portion of image content identified with the relative running (e.g., a sibling chasing a dog) and corresponding to the word “RUN.” Media content portions of image content can also be recognized according to words spoken, for example, where if the relate spoke the word run, rather than actually running, in response to the user sending a message input with the word “RUN” as part of the message to be generated then the portion of video of the relative speaking the word run is generated.

The image correlation component 808 operates to correlate a set of words or phrases (as tags or labels with metadata) based on the set of predetermined criteria including a matching action, a matching facial expression, a matching event(s) within one or more images, a matching voice tone or anything depicted or occurring within the set of images. The set of predetermined criteria, for example, can be distinguished somewhat from the set of classification criteria. The classification criteria, for example, provides criteria about the images (classification criteria—person, people, things in the image, time of events, place, date, time frames, etc.) that match segments or portions of the image content. The set of predetermined criteria can include the events, a type of action, expression, expression or circumstances occurring in one or more of the images (recognizable events—expression, emotion, action, speech, sounds occurring, etc.) matching a label or metadata that can include a word or phrase identifying the media content portion. Accordingly, the image analysis component 806 can determine portions of media content provided in a set of inputs, such as from a user's personal data store, according to the set of classifications and/or the set of predetermined criteria, and the image correlation component 808 correlates (associates) the portions with a word, phrase or other such identifier that enables creation of the multimedia message from additional or different inputs 814 (message inputs) according to the set of predetermined criteria, for example.

In one embodiment, the image correlation component 808 is further configured to correlate the set of words or phrases with the set of media content portions based on portions of audio content of the set of images connected with the set of media content portions. The portions of media content from the set of images received can then be identified with a word, phrase or other identifier according to the words or phrases spoken, or sounds identified within the images. As such, a richer and more personalized multimedia message is able to be generated from personal content.

The message component 810 is configured to generate the multimedia message 816 with the set of media content portions according to a set of message inputs (a text message received, selections inputted of predefined options, a query, and the like). For example, the multimedia message 816 includes one or more media content portions (e.g., video portions, image portions, audio portions and the like) that are combined to form a continuous video stream. The message inputs received via the communication channel 814 can include a text based message having words or phrases that are matched with the words or phrases correlated to or identified with the media content portions by the image correlation component 808.

In one example, a user can provide to the system 800 a set of inputs comprising a video or images. The system 800 components operate to analyze, splice, identify and correlate portions of the video and images capture or provide by the user. In one embodiment, the system includes the device capturing the video or image, and/or enables an image to be drawn or created thereon, such as by a stylus, touch pad, digital ink, etc. The system receives the content from the user as a set of images, for example, and processes the image content received (e.g., via the image component 804, the analysis component 806, the image correlation component 808, and the message component 810) into media content portions. The system 800 can then receive a set of messages or message inputs for generating a multimedia message according to the portions. For example, a message input can be a text based message stating, “I love puppies! Can we buy one?” In response to the message, the system 800 generates a multimedia message with the media content portions so that when viewed the multimedia message includes one or more of the portions from the set of image content received that communicate in a sequence the intended message “I love puppies! Can we buy one?” The multimedia message can include multiple different media content portions corresponding to portions (words or phrases) of the message inputs, for example. As such, when the multimedia message is communicated a sequence (e.g., video stream) of images, including portions of video and/or audio, can be viewed as the communicated multimedia message. In one embodiment, the text message or message inputs can be voiced, overlayed, and/or otherwise generated with the video/audio images that are combined as the multimedia message. Alternatively, the final multimedia message does not have the initial message inputs incorporated in the multimedia message, which can be defined according to a user preference.

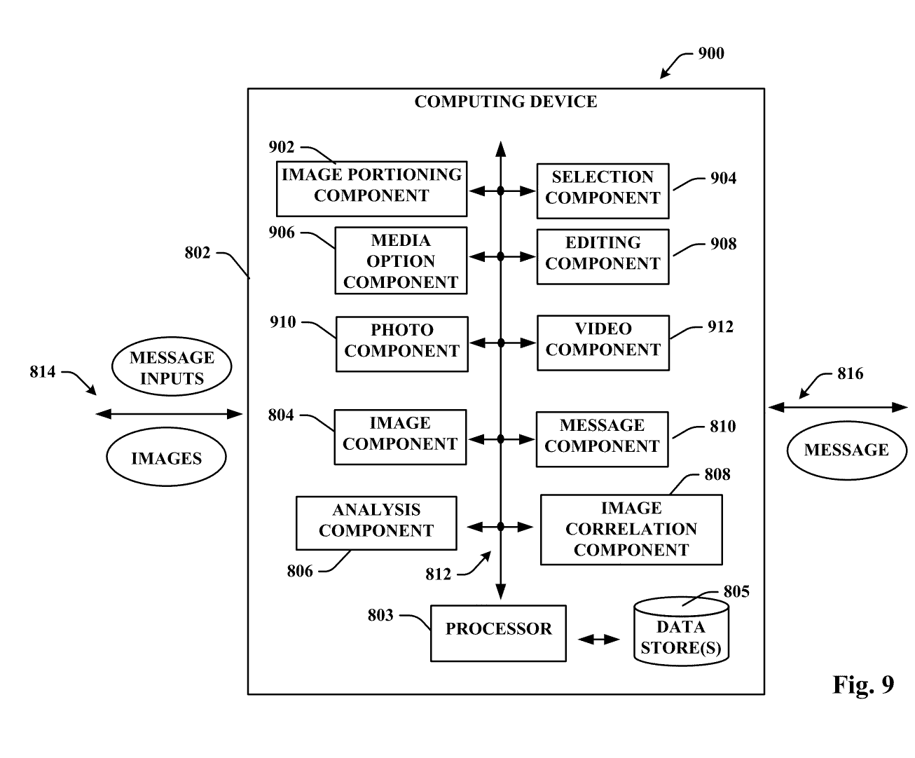

Referring now to FIG. 9, illustrated is the system 900 for generating a multimedia message from a set of image content according to various embodiments disclosed herein. The system 900 includes similar components as discussed above in FIG. 9, and further includes an image portioning component 902, a selection component 904, a media option component 906, an editing component 908, a photo component 910 and a video component 919.

The image portioning component 902 is configured to splice the set of image content and extract the set of media content portions according to the set of predetermined criteria. For example, images within the set of images can be spliced, or extracted based on a matching of audio content, an action, an expression, an emotion with one or more words or phrases. In addition or alternatively, the image portioning component can extract media content portions according to a set of classification criteria as discussed above (e.g., a theme, actor, holiday, event, time period and the like). The image portioning component splices the media content according to portions identified by the analysis component 806. The portions identified can be marked and then further spliced in order to be placed or concatenated together with other media content portions in a multimedia message. In addition, the extracted portions can be sorted in the data store 805 in order to be further classified and/or tagged with a word or phrase by a user.

A selection component 904 is configured to receive a selection that identifies a media content portion with a user inputted tag, word or phrase. For example, the media content portions correlated with a set of words or phrases can be modified by a user to have a different set of words or phrases associated with or correlated to the media content portion. For example, a video segment or portion having the word singing associated with it, can be edited to have a different word associated with it. In one embodiment, the labeled word or phrase associated with the media content portion can be presented with the media content portion generated within the multimedia message. In this way, the multimedia message includes textual labels connected to each portion and one or more portions comprising a video conveying a message for the user to send.

The editing component 908 is configured to edit the set of words or phrases associated with the set of media content portions according to a set of user preferences, which can include a preference for a number of words to connect with the portions (one or more images), a set of descriptors for each portions (e.g., colors, events, words spoken, sounds, music, date, etc.), a set of verbs, a set of nouns, a set of names, a set of places, a set of metadata, and the like) so that the words or phrases connected with each portion from the set of home videos or personal photos are indicative of the user's preferences for labeling. For example, a set of images may be labeled as a red ball, moving, rolling, on green grass, and also the word “catch” because it happens to also be spoken within the video. A user preference can be set to only label the portions within the video according to a person's name, an object identified (ball), a color illustrated, and from other characteristics rather than having multiple different options for words connected with one set of image content. Additionally, a set of user preferences for one set of video/audio/image content can be designated for nouns, colors, places, etc. while a different set of user preferences for correlating words or phrases can be designated to a different set of video/audio/image content. This enables a user to input various different types of videos or images and guide the analysis and correlation of various types of media content for configuring multimedia messages. As such, when the user generates a multimedia message by typing a phrase or text based message (message inputs), the system can correspond certain words or phrases in the message inputs with particular words or phrases connected to different sets of media content stored based on the user preferences for each. Nouns, for example, can be connected to a video of a dog filmed, and verbs could be connected to a different film of a party.

The media option component 906 is configured to generate the set of media content portions generated from the set image content and a set of cinematic media content portions generated from a set of cinematic movie content as options for a correlation with the set of words or phrases based on a selected option, wherein the set of cinematic movie content is stored in a data store and comprises content of a film that was featured in a public theatre. The media option component 906 provides options for a user to select from, in which portions of media content from different sets of videos (e.g., home video and cinematic video) can be provided in the multimedia message. A user, for example, could prefer a scene from a movie (e.g., Rocky) to represent a word, rather than a segment of a home video. Both portions can be presented to the user in order for the user to correlate certain phrases or words with. Alternatively or additionally, portions from different sets of videos or images can correlate with a word or phrase so that user is presented with an option to choose among with the generation of each multimedia message. In one example, the multimedia message generated can include at least one of the set of media content portions from the set of image content (home videos or personal images) and/or at least one of the set of cinematic media content portions. A random selection could further be received to randomly select from among the options to place within the multimedia message as representative of a word or phrase received as the message inputs 814.

The photo component 910 and the video component 919 are respectively configured to capture videos and/or photos in order to generate the image content, in which media content portions are generated from for a multimedia message. For example, rather than receiving the set of images from an external data store, or the data store 805, the images and videos can be directly captured for the user to generate a video stream of video/audio/images automatically based on text or message inputs entered or received by the system 900.

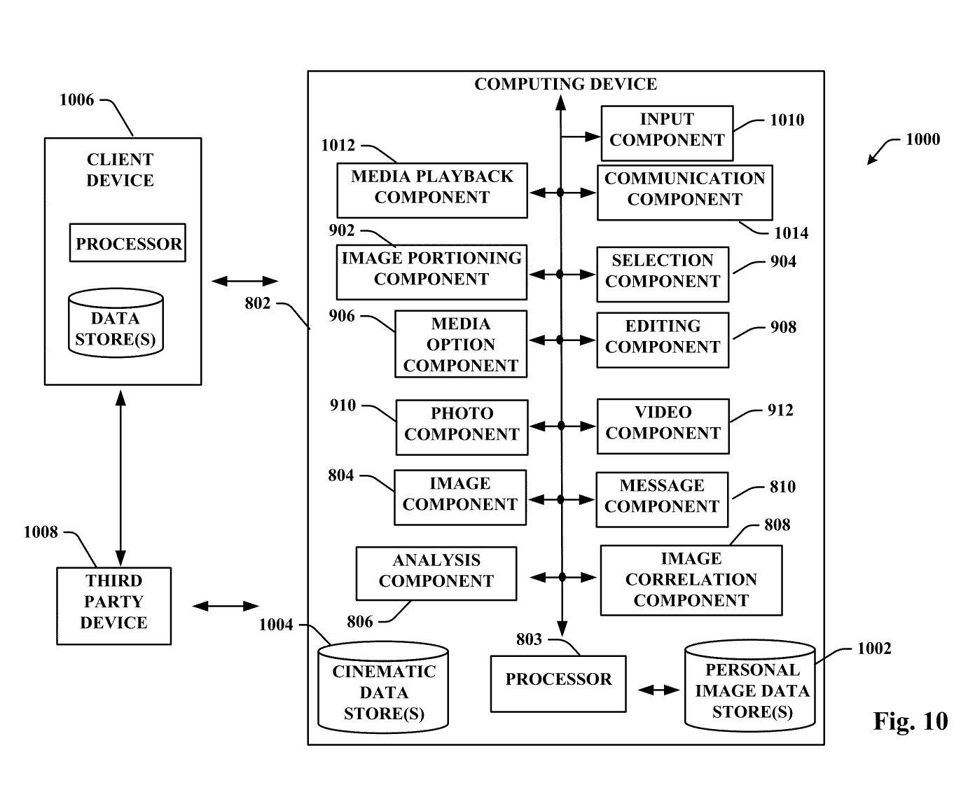

Referring now to FIG. 10, illustrated is a system 1000 in accordance with various embodiments disclosed. The computer system 802 further includes similar components as discussed above and further includes a message input component 1010, a media playback component 1012 and a communication component 1014.

The system 1000 includes a personal image data store 1002 for storing personal home videos and images created on the computing device 802 and/or a different client device 1006, and/or third party device (e.g., a server, or other device), for example. The system 1000 further includes a cinematic data store 1004 for storing cinematic videos or images that have been viewed or presented in a public theatre, such as Hollywood films or movies that have been licensed or purchased. Either data store 1002 or 1004 can also include media content (video/audio/images) from a third party device 1008 for generating a repository of videos, which can be provided on a cloud network, at the computing device 802, the third party device/server 1008, another client device 1006 and/or the like, in which the body of media content that has been processed by the various components described herein can be presented on a social network and/or other professional or family network.

The message input component 1010 is configured to receive a set of message inputs from which the multimedia message is generated. As described above, portions of the set of message inputs correspond to portions of the multimedia message. For example, a set of phrases or words in the message inputted into the system 1000 can be matched with different media content portions by a match of the words or phrases correlating with each media content portion. For example, a text message can be received that states “I am laughing!” The words or phrase contained within the message are used to present the media content portions that are connected with the words or phrases to the user, such as in a display (not shown). In addition or alternatively, the message inputs can be received from a text message of a mobile phone, a typed input query, and/or a selection input to a predefined word or phrase.

The media playback component 1012 is configured to generate a preview of the multimedia message that includes generating the at least one textual word or phrase and the at least one video or image sequentially according to a sequence of the set of message inputs received. In addition, the media playback component 1012 can generate a preview of a selected media content portion or segment of media content that is stored in the data store 1002 and/or 1004. This enables a user to preview multimedia messages before sending them, as well as various media content portions that are generated or presented for the words or phrases of the message inputs. The communication component 1014 includes a transceiver, and/or other communication module for receiving wireless communications and sending communication packets incorporating the media content, and the multimedia message. For example, a mobile phone can communicate the multimedia message as a text message having text and video content.

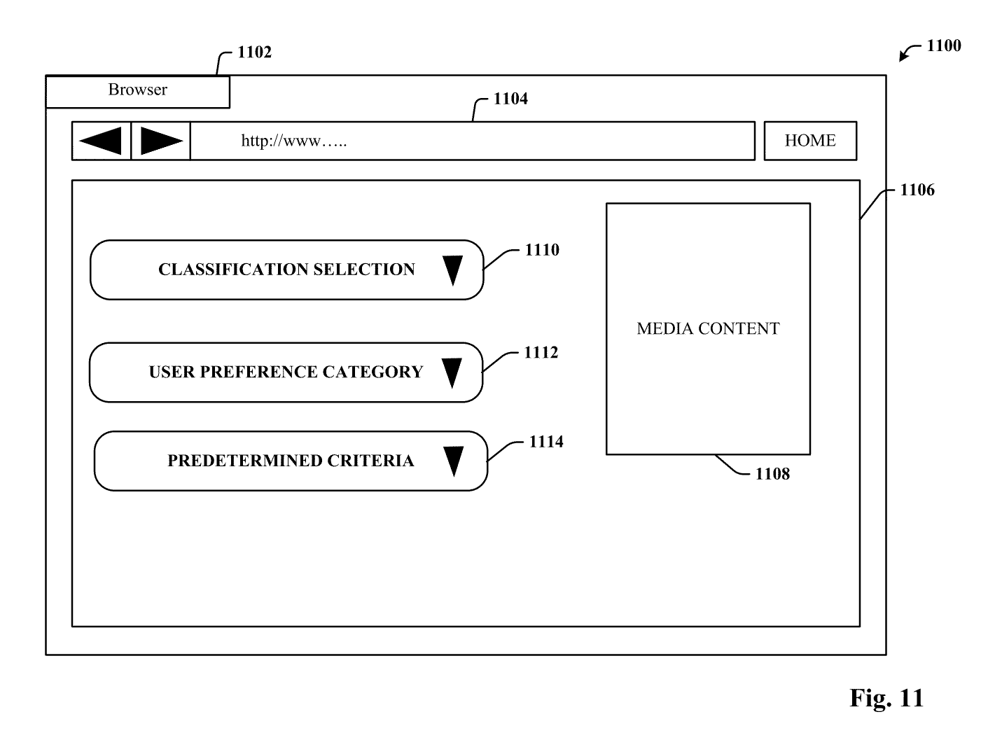

FIGS. 11-13 are described below as representative examples of aspects disclosed herein of one or more embodiments. These figures are illustrated for the purpose of providing examples of aspects discussed in this disclosure in viewing panes for ease of description. Different configurations of viewing panes are envisioned in this disclosure with various aspects disclosed. In addition, the viewing panes are illustrated as examples of embodiments and are not limited to any one particular configuration.

Referring now to FIG. 11, illustrated is an example input viewing pane 1100 in accordance with various aspects described herein. As discussed previously, the message component 810 and/or the media playback component 1012 can generate the multimedia message to be communicated and/or previewed, which can be displayed in the viewing pane. The viewing pane 1100 can be associated via a web browser 1102 that includes an address bar 1104 (e.g., URL bar, location bar, etc.). The web browser 1102 can expose an evaluation screen 1106 that includes media content 1108 for viewing either directly over a network connection, a cloud network or some other connection.

The screen 1106 further includes various graphical user inputs for evaluating the media content 1108 by manual or direct selection online. The screen 1106 comprises a classification selection control 1110, a user preference category control 1112, and a predetermined criteria control 1114. Although the controls generated in the screen 1106 are depicted as drop down menus, as indicated by the arrows, other graphical user interface controls. For example, buttons, slot wheels, check boxes, icons or any other image enabling a user to input a selection at the screen. Theses controls enable a user to log on to an application on a device or enter a website via the address 1104 and further provide input to personalize the multimedia messages.

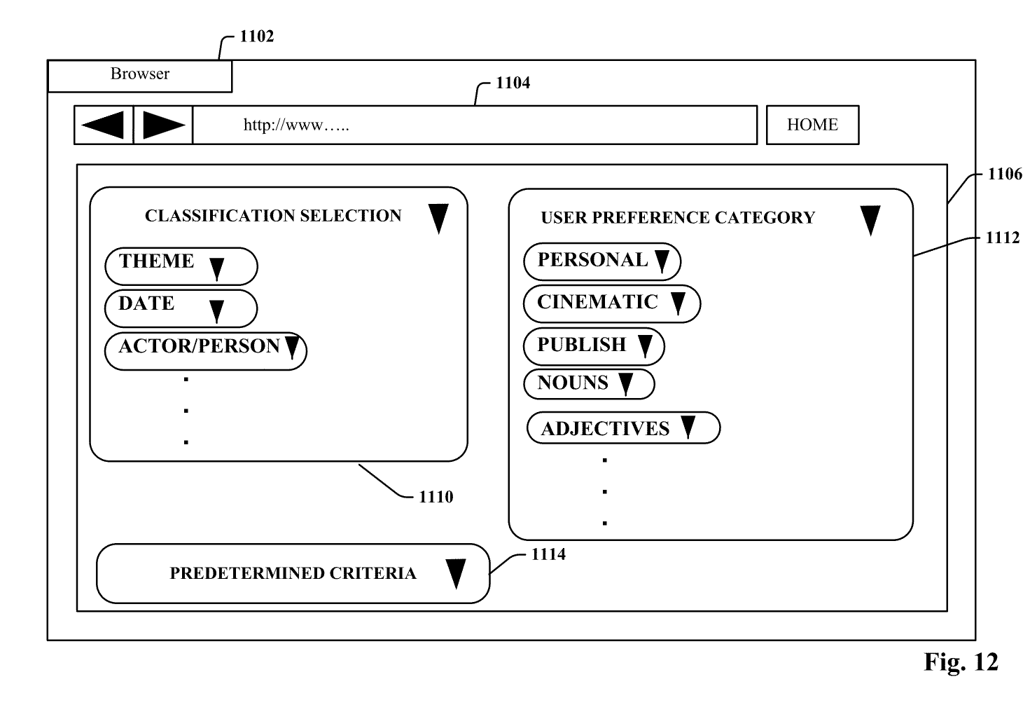

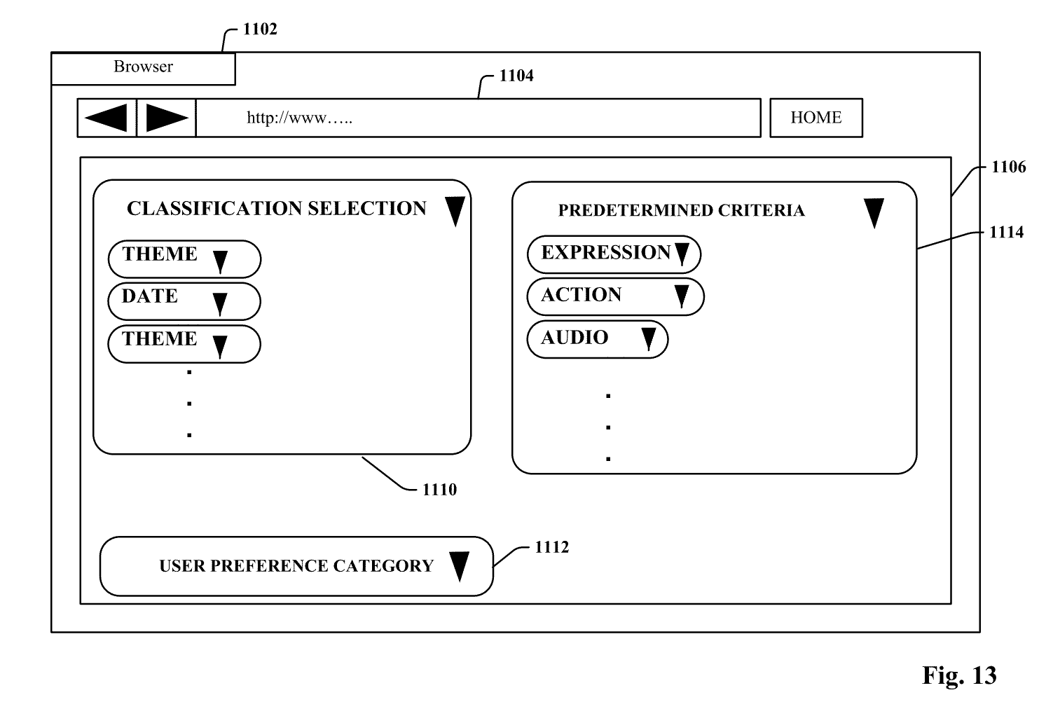

Referring now to FIG. 12 and FIG. 13, illustrated is an example of the different items displayed in the screen 1106 in accordance with various aspects described herein. Further, although these items are displayed for selection, these examples are also provided to illustrate the different classification selection controls 1110, user preference category controls 1112, and predetermined criteria control 1114 that are utilized in conjunction with the above discussed components or elements of the disclosed messaging systems. For example, a user can thus provide inputs expressing desired media content and personalized multimedia messages via a user interface selection, a text, a captured image, a voice command, a video, a free form image, a digital ink image, a handwritten digital image and/or the like.

In one embodiment, the measure selection control 1110 has different options (controls) for classifying media content and/or media content portions extracted from the set of images include video/image/audio content. The classifications can include can include a theme or genre identified, a voice tone, a section of audio associated with the images (e.g., a time period), a time period corresponding to a historical time period or a range of dates, according to actors or actresses identified, a language spoken, a rating, etc. as examples in which media content (video/images/audio) and/or the media content portions can be identified with. Other such classification criteria can also be viewed or generated as well based on a user's taste, metadata associated with the media content and/or characteristics or features of the videos/images/audio content being analyzed.

In another embodiment, the user preference control 1114 has different options (controls) for identifying various types of media content, such as a set of image content from a personal data store captured from a camera, home video recorder, mobile phone and the like, and/or from a cinematic media content that includes film or images with audio content that has been featured in a public theatre (such as Hollywood movies or the like). Various types of user preferences can be included such as a personal selection for obtaining media content portions from a person set of image content received and/or stored, a cinematic selection for movies obtained by a license or publicly release, a publish control to provide multimedia message online and/or to retrieve published image content, preference for media content portions to be labeled, tagged, or otherwise correlated with a word or phrase, such as for nouns, adjectives and/or other grammatical structures. Other preferences can also be implemented by the systems disclosed herein for portions and generated multimedia message from a set of text messages, query terms, selected text, and the like.

FIG. 13 further illustrates a set of predetermined criteria control 1114 that can be selected for generating media content portions and/or selecting sets of media content by which portions are extracted from. The predetermined criteria can include various options including identification of one or more images with a particular facial expression, an action, an event occurring, audio content (spoken or not), sounds and/or other characteristics related to occurrences or events within the video/image/audio content, a time frame of events by which the portions of content are extracted from, and/or a manual selection or splicing of the image content (including one or more scenes or images), for example. In addition, an audio control can be provided for determining portions of audio content associated with videos/images/audio content. For example, sound bites can be used as part of the multimedia message that can be of just song portions, speeches, interviews, audio books, videos and/or images having audio content.

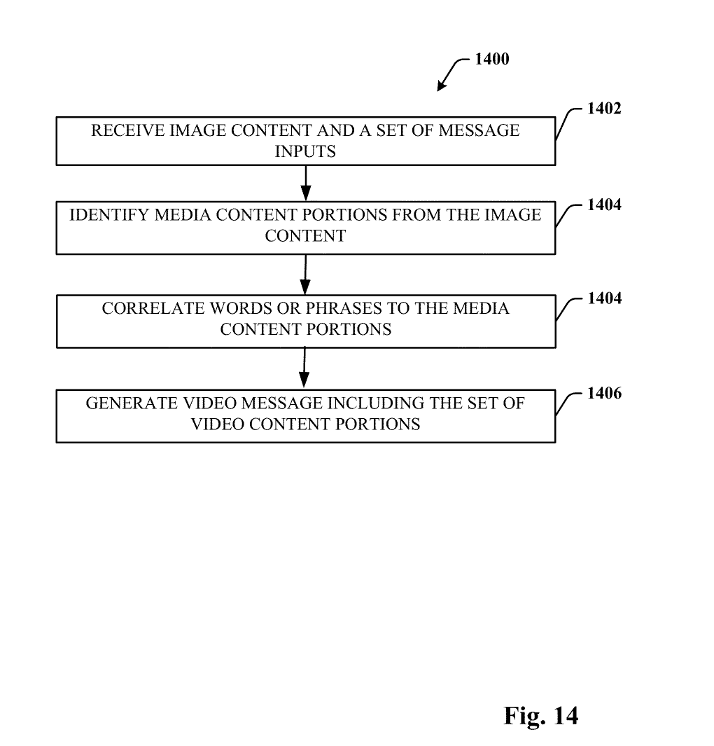

An example methodology 1400 for implementing a method for a system such as a system for generating a multimedia message with media content is illustrated in FIG. 14. The method 1400 initiates and at 1402, the method includes receiving, by a system including at least one processor, a set of image content stored in a personal video or personal image data store and a set of message inputs for generation of a multimedia message. In one embodiment, the multimedia message can include at least one video or image from the set of media content portions generated from the set of image content and also corresponds to at least one word or phrase of the set of message inputs as part of the multimedia message. For example, the multimedia message can partially comprise text, such as in a text message and then also include portions of video that convey the remained of the message. The video portions can be from different videos (different movies, films, personal videos, personal photos, audio, etc.). The multimedia message can include at least one video or image from the set of media content portions generated from the set of image content (personal content), at least one textual word or phrase received in the set of message inputs and audio content that corresponds with at least one portion of the set of message inputs. In another embodiment, the set of image content (personalized content from a personal device or home capturing device) comprise a set of video content having associated audio content, by which the set of image content and the set of message inputs are received via a same communication pathway, such as via a network from the same device, a same data store in communication with the processor, a set of text message, multimedia message such as in a Short Message Service (SMS) and/or a Multimedia Messaging Service (MMS).

At 1404, the method includes identifying a set of media content portions from the set of image content that include at least one digital image of the set of image content stored in the personal video or personal image data store for incorporation into the multimedia message. At 1406, a set of metadata including a first set of words or phrases are correlated with the set of media content portions. At 1406, the multimedia message is generated with the set of media content portions that correspond to the first set of message inputs. In one embodiment, generating the multimedia message with the set of media content portions that correspond to the set of message inputs can include matching the first set of words or phrases with a second set of words or phrases of the set of message inputs.

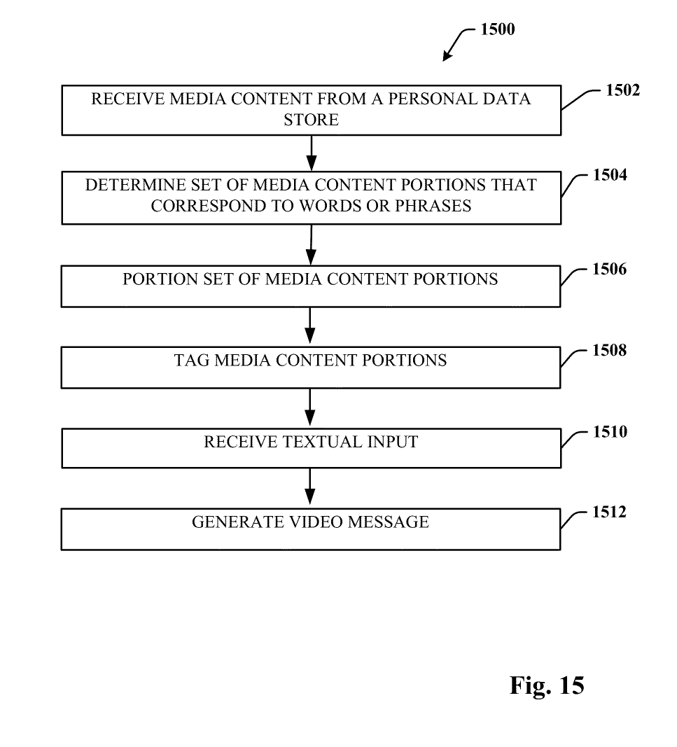

An example methodology 1500 for implementing a method for a system such as a system for generating a multimedia message with media content is illustrated in FIG. 15. The method 1500, for example, provides for a system to evaluate various media content inputs and generate a sequence of media content portions that correspond to words, phrases or images of the inputs.

At 1502, the method initiates with receiving a set of media content for generating a multimedia message from a personal media data store. The set of media content can be videos, photos, images drawn or created on a personal computer, a mobile device, a smart phone and the like, for example.

At 1504, the method includes determining a set of media content portions including content that corresponds to a word or a phrase of associated audio content, such as portions of video associated with a word or phrase. The word or phrase can be a determined word or phrase, such as by analysis of an image to determine an action, as well as a word or phrase from audio content.

At 1506, the method includes portioning the set of media content based on the one or more words, phrases and actions into the set of media content portions. At 15015, the method includes tagging the set of media content portions with a word or a phrase. At 1510, the method includes receiving textual input having words or phrases for the multimedia message. At 1519, the method includes generating the multimedia message with the set of media content portions according to the textual input including words or phrases that match the tagged word or phrase of the set of media content portions.

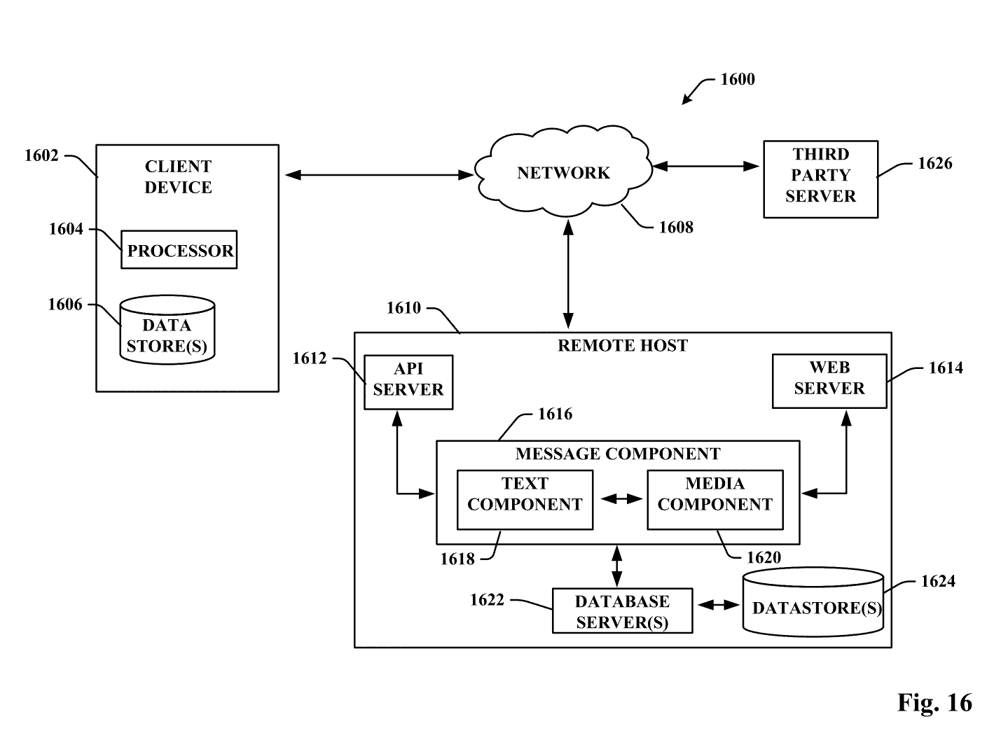

Referring to FIG. 16, illustrated is an example system 1600 for generating one or more messages having video and/or audio content that corresponds to a set of text inputs in accordance with various aspects described herein. The system 1600 is operable as a networked messaging system that communicates multi-media messages via a computing device, such as a computing device, a mobile device or mobile phone. The system 1600 includes a client device 1602 that includes a computing device, a mobile device and/or a mobile phone that is operable to communicate one or more message to other devices via an electronic digital message (e.g., electronic mail, a text message, a multimedia text message and the like). The client device 1602 includes a processor 1604 and at least one data store 1606 that processes and stores portions of media content such as video clips of a video comprising multiple video clips, portions of videos and/or portions of audio content and image content that is associated with the videos. The video clips, video segments and/or portions of videos can also include song segments, sound bites, and/or other media content such as animated scenes, for example. The clips, portions or segments of media content stored can be stored in an external data store, such as a data store 1624, in which the media content can include portions of songs, speeches, and/or portions of any audio content.

The client device 1602 is configured to communicate to other client devices (not shown) and to a remote host 1610 via a network 1608. The client device 1602, for example, can communicate a set of text inputs, such as typed text, audio or some other input that generates a digital typed message having alphabetic, numeric and/or alphanumeric symbols for a message. For example, the client device 1602 can communicate via a Short Message Service (SMS) that is a text messaging service component of phone, web, or mobile communication systems, using standardized communications protocols that allow the exchange of short text messages between fixed line and/or mobile devices. Any other message such as an email or any electronic message (e.g., electronic mail) is also envisioned.

The client device 1602 is operable to communicate multimedia content via the network 1608, which can include a cellular network, a wide area network, local area network and other networks. The network 1608 can also include a cloud network that enables the delivery of computing and/or storage capacity as a service to a community of end-recipients that entrusts services with a user's data, software and computation over a network. For example, the client device 1602 can include multiple client devices, in which end users access cloud-based applications through a web browser or a light-weight desktop or mobile app while software and user's data can stored on servers at a remote location.

The system 1600 includes the remote host that is communicatively connected to one or more servers and/or client devices via the network 1608 for receiving user input and communicating the media content. A third party server 1626, for example, can include different software applications or modules that may host various forms of media content 1602 for a user to view, copy and/or purchase rights to. The third party server 1626 can communicate various forms of media content to the client device 1602 and/or remote host 1610 via the network 1608, for example, or via a different communication link (e.g., wireless connection, wired connection, etc.). In addition, the client device can also enable viewing, interacting or be configured to communicate input related to the media content. For example, the client device 1602 can have a web client that is also connected to the network 1608. The web client can assist in displaying a web page that has media content, such as a movie or file for a user to review, purchase, rent, etc. Example embodiments can include the remote host 1610 operable as networked system via a client machine or device that is connected to the network 1608 and/or as an application platform system. Aspects of the systems, apparatuses or processes explained in this disclosure can constitute machine-executable component embodied within machine(s), e.g., embodied in one or more computer readable mediums (or media) associated with one or more machines. Such component, when executed by the one or more machines, e.g., computer(s), computing device(s), electronic devices, virtual machine(s), etc. can cause the machine(s) to perform the operations described.

The network 1608 is communicatively connected to the remote host 1610, which is operable as a networked host to provide, generate and/or enable message generation on the network 1608 and/or the client device 1602. The third party server 1626, client device 1602 and/or other client device, for example can requests various system functions by calling application programming interfaces (APIs) residing on an API server 1612 of the remote host 1610 for invoking a particular set of rules (code) and specifications that various computer programs interpret to communicate with each other. The API server 1612 and a web server 1614 serves as an interface between different software programs, the client machines, third party servers and other devices and facilitates their interaction with a message component 1616 and various components having applications for hardware and/or software. A database server 1622 is operatively coupled to one or more data stores 1624, and includes data related to various described components and systems described herein, such as portions, segments and/or clips of media content that includes video content, imagery content, and/or audio content that can be indexed, stored and classified to correspond with a set of text inputs.

The message component 1616, for example, is configured to generate a message such as a multimedia message having a set of media content portions. The message component 1616 is communicatively coupled to and/or includes a text component 1618 and a media component 1620 that operate to convert a set of text inputs that represent or generate a set of words or phrases to be communicated by the client device 1602 and/or the third party server 1626. For example, the set of text inputs can include voice inputs, digital typed inputs, and/or other inputs that generate a message with words or phrases, such as a selection of predefined words or phrases. For example, text input can be received by the text component 1618 and communicatively coupled to the media component 1620.

The media component 1620, in response to a set of text inputs received at the text component 1618 is configured to generate a correspondence of a set of media content portions with the set of text inputs. For example, words or phrases of the text input can be associated with words and phrases of a video. In addition or alternatively, the media component 1620 is configured to dynamically, in real time generate corresponding video scenes, video/audio clips, portions and/or segments from an indexed set of videos stored in the data store 1624, data store 1606, and/or the third party server 1626.

The media component 1620 is configured to determine a set of media content portions that respectively correspond to the set of words or phrases according to a set of predetermined criteria, such as by storing and grouping the media content portions or segments, for example, according to words, action scenes, voice tone, a rating of the video or movie, a targeted age, a movie theme, genre, gestures, participating actors and/or other classifications, in which the portion and/or segment is corresponded, associated and/or compared with the phrases or words of received inputs (e.g., text input). In one example, a user, such as a user that is hearing impaired, can generate a sequence of video clips (e.g., scenes, segments, portions, etc.) from famous movies or a set of stored movies of a data store without the user hearing or having knowledge of the audio content. Based on the set of text inputs the user provides or selects, portions of video movies/audio can be provided by the media component 1620 for the user to combine into a concatenated message. The message can then be communicated by being played with the sequence of words or phrases of the textual input by being transmitted to another device, and/or stored for future communication. The media component 1620 therefore enables more creative expressions of messaging and communication among devices.

In another example, a client device 1602 or other party generates the message via the network 1608 at the remote host 1610, and then the remote host 1610 communicates the message created to the client device 1602, third party server 1626 and/or another client for further communication from the client device 1602. In addition or alternatively, the message can be generated directly at the client via an application of the remote host 1610. The messages generated can span the imagination, and correspond to phrases or words according to actions or images that make up portions of media content or video content. For example, an angry gesture can be identified via the text input and a gesture corresponding to the identified angry gesture can be identified within the set of media content portions, and, in turn, placed within the message, such as a video message with scenes or clips corresponding to the text input. A middle finger being given by an actor in a famous movie, for example, could correspond to certain curse words or phrases within the set of text inputs received at the text component 1618, and then concatenated into the message by the message component 1616 to correspond to the emoticon, icon, or text based graphic as part of the message made of corresponding movie scenes (i.e., portions, segments, and/or clips of video).

In one embodiment, the media component 1620 is configured to generate a set of media content portions that correspond to the words or phrases of text according to a set of predetermined criteria and/or based on a set of user defined preferences/classifications. For example, the media component 1620 can include a set of logic (e.g., rule based logic or other reasoning processes) that is implemented with an artificial intelligence engine (not shown) such as via a rule based logic, fuzzy logic, probabilistic, statistical reasoning, classifiers, neural networks and/or other computing based platforms. The media component 1620 is configured to identify and organize portions of video and/or audio content for generation of multimedia messages based on textual inputs. As stated above, the text inputs can be selected, communicated and/or generated onsite via a web interface of the remote host 1610. The message component 1616 responds to the text input by dynamically generated a multimedia message that corresponds to the words or phrases of the text message of the text input. The portions of media content can correspond to the words or phrases according to predefined/predetermined criteria, for example, based on audio that matches each word or phrase of the text inputs.

In one embodiment, words that have little or less meaning, such as articles (e.g., the, a, an, etc.) can be set by a user preference to be ignored, altered to a different article and/or incorporated with the word or phrase in a media content portion that corresponds to the input word or phrase received. If particular words are ignored, the message component 1616 can still generate the message according to other word types, such as verbs, nouns, adjectives, adverbs, prepositions, etc. and still create the multimedia message from the text inputted for the message. Although each word of a message, including words such as articles, could be selected to also provide media content portions that also correspond to the words or phrase, and thus, the system is not limited in capability or options to the user for words or phrases of a message to be generated in various media content portions.

In another embodiment, the multimedia message can be generated to comprise a sequence of video/audio content portions from different videos and/or audio recordings that correspond to words or phrase of the input received (e.g., a text inputted message). The message can be generated to also display text within the message, similar to a text overlay or a subtitle that is proximate to or within the portion of the video corresponding to the word or phrase of the input. In the case of audio, the text message can also be generated along with the sound bites or audio segments (e.g., a song, speech, etc.) corresponding to the words or phrases of the text.

In another embodiment, a text message received via text input to the text component 1618 is also configured to receive emoticons, text-based images, such as a colon and a closed parenthesis for a smiley face or any other text-based image or graphic. The media component 1620 is configured to identify the text-based image and generate a video scene or image that corresponds thereto. For example, a smiley face received as a colon and a closed parenthesis could initiate the media component 1620 to generate a corresponding image of video, such as a smile from the Cheshire cat in the movie “Alice and Wonderland.”

In another embodiment, the message component 1616 is further configured to generate a voice overlay via a voice overlay component (not shown). The text component 1618 receives the text input and is further configured to dynamically generate a voice that corresponds to the text, which is one example of a user preference that can be set to operate along with the operations discussed above. The user preference can provide for a female, male, young, old, and/or tone of voice for the voice overlay, which is generated to accompany the set of media content assembled as part of the message. For example, a text input could be the following: “How are you? It's a beautiful morning!” In response, the message component 1616 is operable to generate a message with the text message, with a voice overlay in a chosen voice, and/or the sequence of video/audio content that corresponds to each word or phrase of the message. In addition, the audio of a video could be muted or overlap the voice overlay for a duet vocal, and video message. Likewise the video could be blocked to only generate the audio of the corresponding video portion.

As stated above, the media component 1620 generates a message of media content portions that correspond to text input according to a set of predetermined criteria. The predetermined criteria, for example, include a matching classification for the set of video content portions according to a set of predefined classifications, a matching action for the set video content portions with the set of words or phrases, or a matching audio clip (i.e., portion of audio content) within the set of video content portions that matches a word or phrase of the set of words or phrases. In addition, the matches or matching criteria of the predetermined criteria can be weighted, so that search results or generated results of corresponding media content portions are not exact. For example, a weighting of the predetermined criteria including a matching audio content for the set of video content portions can be weighted at only a certain percentage (e.g., 75%) so that the generated corresponding content generates a plurality of media content portions for a user to select from in building the message that not only matches the word or phrase the portion corresponds to, but also includes grunts, onomatopoeias, conjunctions or dialects of a word such as “y'all” for “you all,” if one is southern born.

Further, the media component 1620 is configured to generate a message of media content portions (e.g., portions of video and/or audio that accompanies or does not accompany video), in response to the words or phrases of text according to a set of user pre-defined preferences/classifications (i.e., classification criteria). Classifying the set of media content portions (e.g., video/audio content portions) according to a set of predefined classifications includes classifying the media content portions according to a set of themes, a set of media ratings, a set of target age ranges, a set of voice tones, a set of extracted audio data, a set of actions or gestures (e.g., action scenes), an alphabetical order, gender, religion, race, culture or any number of classifications, such as demographic classifications including language, dialect, country and the like. In addition, the media content portions can be generated according to a favorite actor or a time period for a movie. Thus, a user can predefine preference for the message component 1616 to dynamically generate videos on demand, in real time, dynamically or in a predetermined classification according to the set of video content portions that correspond to words or phrases of a text message.

In another embodiment, the message component 1616 is configured to generate media content portions that include video portions of a video mixed with audio portions of another movie that both correspond to words or phrases in a text message. For example, the message component 1616 is configured to generate video scenes that correspond to a word or phrase of a text message, in which the audio of the movie can correspond or some other content correspond to the textual word or phrase. While one scene or segment of an audio and/or video component can be generated to correspond with the phrase or word, any number of scenes, segments or audio portions can also be generated and mixed so that a video saying the word “Hello” by the actor John Wayne can be replaced with audio from another movie with the same audio, but different video, such as from Jim Carrey. As such, the audio of one video portion can be replaced with the audio of another video portion and selected to represent the particular word or phrase from the textual input for the multimedia message.

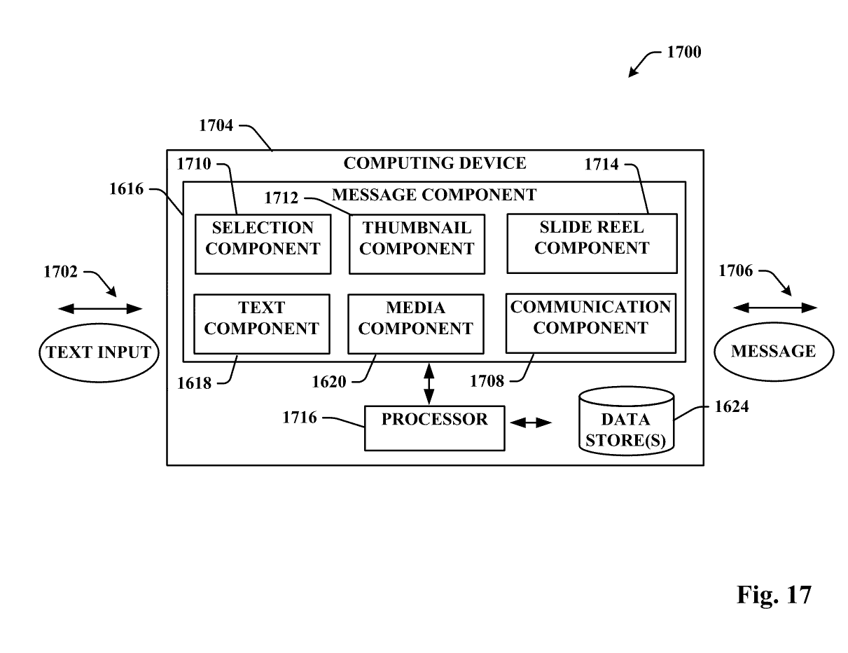

Referring now to FIG. 17, illustrated is a system 1700 that generates a message having various media content portions to correspond to a text message input in accordance with various embodiments disclosed in this disclosure. The system 1700 includes a computing device 1704 that can comprise a remote device, a personal computing device, a mobile device, and any other processing device. The computing device 1704 includes the message component 1616, a processor 1716 and the data store 1624. The computing device 1704 is configured to receive a text input 1702 via a voice input, a typed text input and/or via a selection of a textual word or phrase in the data store 1624.

The message component 1616 includes the text component 1618 that is configured to receive the set of text inputs 1702 and to generate a set of words or phrases of a message 1706. The message 1706 includes a set of video images or video scenes, clips, portions segments, etc. that correspond to the text input 1702. The computing device 1704 is configured to create the message 1706 as a multimedia message that has scenes or segments from different videos or movies that enact and/or have audio content that reflects, is indicative of, or corresponds to the words or phrases of the text input 1702.

The message component 1616 includes the text component 1618 and the media component 1620, which is configured to generate a set of media content portions (e.g., video scenes, and/or audio portions) of a media content that corresponds to words or phrases of the text input 1702, which can be communicated to the system by a user, such as by an electronic message, selections of text, and any other means for a message to be generated from the inputted text. The message component 1616 further includes a communication component 1708, a sli 1710, a thumbnail component 1712 and a slide reel component 1714. The communication component 1708 is configured to communicate the message 1706 to a different device via a network, such as a mobile device or another computing device. The communication component 1708 can include a transceiver, for example, or any other communicating component for transmitting and/or receiving multimedia messages, video messages, text message, audio messages and/or any electronic message to a user.

The selection component 1710 is configured to receive a selection of a media content portion of a plurality of media content portions associated with a word or phrase of the set of words or phrases to include in the set of media content portions. Based on the received selection, the thumbnail component 1712 is configured to generate a set of representative images that represent the set of media content portions corresponding to the set of words or phrases. The representative images can include thumbnail images such as still scene shots, and/or metadata representative of and associated with each media content portions generated by the media component 1620 and/or that is selected by a composer of the message. Each thumbnail image can represent a word or phrase of the text message and of a word, phrase, image, and/or action of the media content portion represented. The slide reel component 1714 is configured to present the set of representative images of the thumbnail component 1712 in a selected order, in which the message 1706 is to be viewed by a recipient of the message. In one example, the message is composed along a slide reel that is generated by the slide reel component 1714 for the selections and the order to be defined. The selections received populate the slide reel in a concatenated sequence of video and/or audio content portions, in which the message 1706 will be composed. The order can be altered and the selected video/audio content portions assigned to each slide or reel can be altered. For example, if a video/audio content portion expressing the word “dog” is desired to be changed to “cat,” the thumbnail portion representing “dog” can be dragged out and another media content portion representing “cat” can replace the one representing “dog” by being dragged/dropped in the same location in along the slide reel. Further, the slide reel component 1714 is also operate to generate a preview of the concatenated sequence of video and/or audio content portions for a user to view before sending the final composed message.

The selection component 1710 is configured to receive a selection of a media content portion of a plurality of media content portions associated with a word or phrase of the set of words or phrases to include in the set of media content portions. For example, a query term or phrase could be entered to search for video content and/or audio content that includes or expresses the particular word or phrase. Upon receiving one or more results, the message component 1616 can receive a selection of the media content, splice or edit the media content portion having the word or phrase selected and represent it as an option to be included within the slide reel, or within another view pane, individually or with a group of other media content portions.

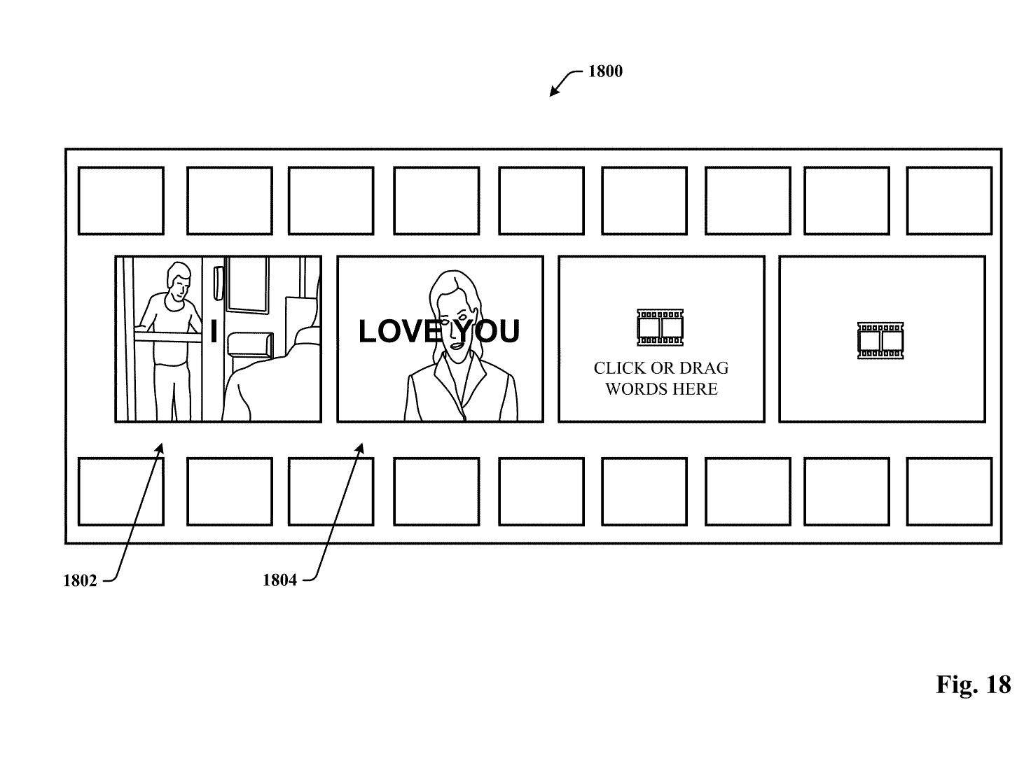

FIG. 18 illustrates one example of a generated slide reel by the slide reel component 1714 having a set of representative images in a selected order. The text words or phrases “I LOVE YOU” are presented as an overlay of each representative image. However, the text can be proximate to or alongside each thumbnail image slide 1802 and/or 1804. In one example, the word “I” is depicted to correspond with a selected media content portion comprising a video scene from a movie with an actor saying the word “I” with a certain tone and reflection, and is previewed in a slide 1802 having a thumbnail image of the video content portion that corresponds to the word “I”. Likewise, the next slide in the concatenated order includes the phrase “LOVE YOU” and corresponds to a set of scenes or a video/audio media content portion from a movie with a different actor of a different context expressing the phrase “LOVE YOU.” In addition, other media content portions could be selected to fill other reels, such as “VERY” and “LITTLE” after the slides 1802 and 1804. In addition, the thumbnail images can be other types of image data or representative data of the media content portions corresponding to a word, phrase and/or an image received, as well as include metadata that pertains to the media content portion. For example, video clips can be represented with thumbnail images and/or other data such as metadata that details properties, classification criteria, information about actors, filmed date, genre, rating, themes, awards received, and any data pertaining to the particular video that the video clip is cut or sliced from. Other forms of media content portions can also include metadata represented in a thumbnail image or other image such as audio data having information about the song, singer, speech, and/or other vocal expression. Consequently, the video sequence is represented by the thumbnails of the reel 1800, such as generated by the slide reel component 1714, but when communicated is played as a video with audio and/or the textual messages concatenated in a single video, such as, for example, the message 1706 of FIG. 17 and/or as generated for preview by the slide reel component 1714. Additionally or alternatively, portions could include only audio, and/or only video, and/or still image portions having audio or not. The text message can be generated with the other media content portions that correspond thereto, and/or without. The text message can be overlaying and/or proximate to as subtitles to the multimedia message.

In some embodiments, the systems (e.g., system 1600) and methods disclosed herein are implemented with or via an electronic device that is a computer, a laptop computer, a router, an access point, a media player, a media recorder, an audio player, an audio recorder, a video player, a video recorder, a television, a smart card, a phone, a cellular phone, a smart phone, an electronic organizer, a personal digital assistant (PDA), a portable email reader, a digital camera, an electronic game, an electronic device associated with digital rights management, a Personal Computer Memory Card International Association (PCMCIA) card, a trusted platform module (TPM), a Hardware Security Module (HSM), a set-top box, a digital video recorder, a gaming console, a navigation device, a secure memory device with computational capabilities, a digital device with at least one tamper-resistant chip, an electronic device associated with an industrial control system, or an embedded computer in a machine.

In some embodiments, a bus further couples the processor to a display controller, a mass memory or some type of computer-readable medium device, a modem or network interface card or adaptor, and an input/output (I/O) controller. The display controller may control, in a conventional manner, a display, which may represent a cathode ray tube (CRT) display, a liquid crystal display (LCD), a plasma display, or other type of suitable display device. Computer-readable medium may include a mass memory magnetic, optical, magneto-optical, tape, and/or other type of machine-readable medium/device for storing information. For example, the computer-readable medium may represent a hard disk, a read-only or writeable optical CD, etc. A network adaptor card such as a modem or network interface card is used to exchange data across the network. The I/O controller controls I/O device(s), which may include one or more keyboards, mouse/trackball or other pointing devices, magnetic and/or optical disk drives, printers, scanners, digital cameras, microphones, etc.

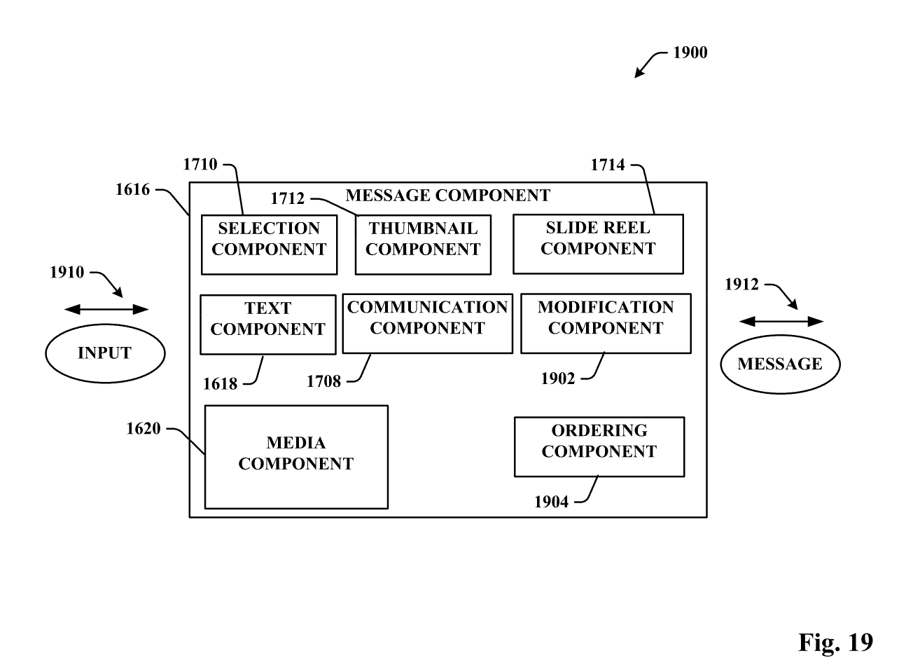

Referring to FIG. 19, illustrated is a system 1900 that generates messages with various forms of media content from a set of inputs, such as text, voice, and/or predetermined input selections that can be different or the same as the media content of the message in accordance with various embodiments herein. The system 1900 includes the message component 1616 that is configured to receive a set of inputs 1910 and communicate, transmit or output a message 1912. The set of inputs 1910 comprise a text message, a voice message, a predetermined selection and/or an image, such as a text-based image or other digital image that is received by the system according to a user's input for a message. The message 1912 that is generated by the message component 1616 is operable to convert the input to a message having different forms of media content, such as a set of videos, audio and/or scenes or images of a movie that correspond to the content or phrases and words expressed by the set of inputs 1910.

The message component 1616 includes the text component 1618, the media component 1620, the communication component 1708, the selection component 1710, the thumbnail component 1712, and the slide reel component 1714, which operate similarly as detailed above. The message component 1616 further includes a modification component 1902 and an ordering component 1904, and the media component 1620. These components integrate as part of the message component or separately in communication to one another to provide an expressive message that is able to be modified creatively and dynamically by a user with a computer device (e.g., a mobile device or the like). The message component 1616, for example, is configured to analyze the inputs 1910 received at an electronic device or from an electronic device, such as from a client machine, a third party server, or some other device that enables inputs to be provided from a user. The message component 1616 is configured to receive various inputs and analyze the inputs for textual content, voice content and/or indicators of various emotions or actions being expressed with regard to media. For example, a text message may include various marks, letters, and numbers intended to express an emotion, which can be discernible by analyzing a store of other texts, or ways of expressing emotions. Further, the way emotions are expressed in text can change based on cultural language, different punctuations used within different alphabets, for example. The message component 1616 thus is configured to translate inputs from one or more users into an image (e.g., an emotion, expression, action, gesture, etc.). The message component 1616 is thus operable to discern the different marks, letters, numbers, and punctuation to determine an expressed word, phrase, expression (e.g., an emotion) and/or image from the input, such as from a text or other input 1910 from one or more users in relation to media content, and based on the input generate a message having one or more different types of media content, such as video, audio, text, imagery, etc.

The modification component 1902 is configured to modify media content portions of the message 1912. The modification component 1902, for example, is operable to modify one or more media content portions such as a video clip and/or an audio clip of a set of media content portions that corresponds to a word or phrase of the set of words or phrases communicated via the input 1910. In one embodiment, the modification component 1902 can modify by replacement of the media content portions with a different media content portion to correspond with the word or phrase identified in the input 1910. For example, the message generated 1912 from the input 1910 via the message component 1616 can include media content portions, such as text phrases or words (e.g., overlaying or proximately located to each corresponding media content portion), video clips, images and/or audio content portions. If desired, the modification component 1902 can modify the message with a new word or phrase to replace an existing word or phrase in the message, and, in turn, replace a corresponding video clip. Additionally or alternatively, a video portion, audio portion, image portion and/or text portion can be replaced with a different or new video portion, audio portion image portion and/or text portion for the message to be changed, kept the same, or better expressed according to a user's defined preference or classification criteria. In addition or alternatively, the message component can be provided a set of media content portions that correspond to a word, phrase and/or image of an input for generating the message 1912 and/or to be part of a group of media content portions corresponding with a particular word, phrase and/or image.

In another embodiment, the modification component 1902 is configured to replace a media content portion that corresponds to the word or phrase with a different video content portion that corresponds to the word or phrase, and/or also replace, in a slide reel view (e.g., slide reel view 1800), a media content portion that corresponds to the word or phrase with another media content portion that corresponds to another word or phrase of the set of words or phrases.

The ordering component 1904 is configured to modify and/or determine a predefined order of the set of media content portions based on a received modification input for a modified predefined order, in which the communication component 1708 can communicate the modified predefined order in the message with the set of words or phrases in the modified predefined order. For example, a message that is generated by the message component 1616 with media content portions to be played in multimedia message such as a video and/or audio message, can be organized in a predefined order that is the order in which the input is provided or received by the message component 1616. The ordering component 1904 is thus configured to redefine the predefined order by either drop, drag, and/or some other ordering input that rearranges the slide reel 1800. For example, the video sequence 1800 could be generated in the order in which the input 1910 is received, namely as “I LOVE YOU.” However, the ordering component 1904 is operable to rearrange the phrase and/or words of the concatenated reels without beginning a new message or providing different input 1910. For example, the message could be re-ordered to generate “YOU I LOVE NOT” by also adding “NOT” having a set of media portions associated therewith. A user or device can reorder the phrase I LOVE YOU (that is, if “LOVE YOU” is pieced as words and not grouped as a phrase) and add the input “NOT.” By inputting “NOT,” the user is then able to select from a plurality of media content portions generated from a data store that corresponds with “NOT.”

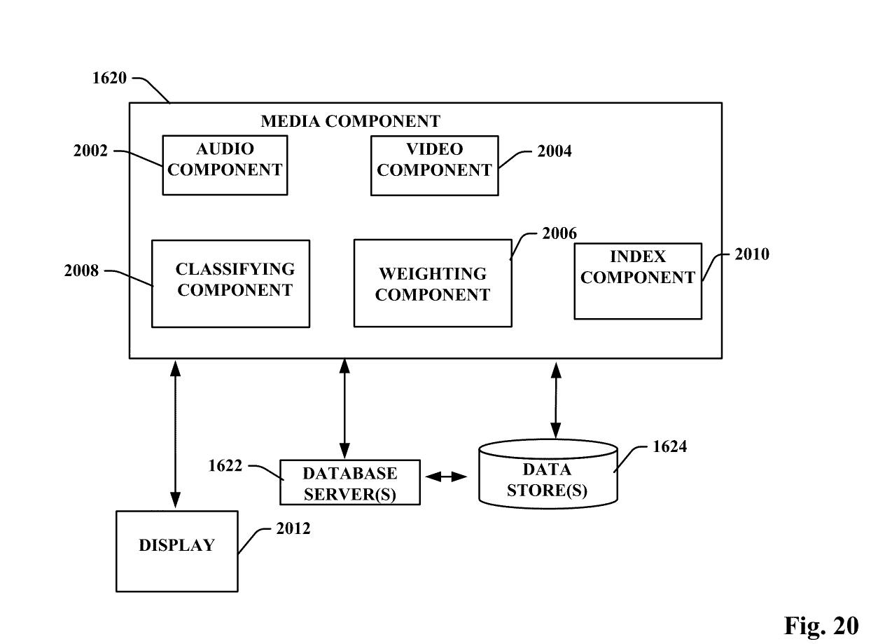

Referring now to FIG. 20, illustrated is an exemplary media component 1620 in accordance with various embodiments disclosed herein. The media component 1620 further includes an audio component 2002 and a video component 2004. The audio component 2002 is configured to determine a set of audio content portions that respectively correspond to the set of words or phrases according to the set of predetermined criteria. The audio content portions can be generated form a data store of songs, speeches, videos, sound bites and/or other audio recordings stored by a user, a server or some other third party. The audio component 2002 can search for audio within a set of videos while the video component 2004 can search for audio within a set of audio recordings. Likewise, the video component 2004 is configured to determine a set of video content portions that correspond to the set of words or phrases according to the set of predetermined criteria and generate them for the media component 1620 to generate a multimedia message as described in this disclosure.

In one embodiment, the audio content and video content generated by the audio component 2002 and the video component 2004 can overlap and generate the same or matching media content in which the audio of each matches a word, phrase and/or image of the inputs received from a user. Additionally, the audio component 2002 and video component 2004 are operable to generate different groups of media content portions to correspond with a phrase, word or image of the input, in which a user could select from the group of media content portions that correspond to a particular phrase, word or image. In addition, a weighting component 2006 can generate a weight indicator according to the set of user classification criteria that can be stored, defined and generated by a classifying component 2008. For example, if a user's preference is set to Western sayings and/or Western movies, then videos and audio of John Wayne or other Western actors could be weight high and ordered in a ranked order from least to greatest or vice versa; while other non-Western media content portions are either not generated or ranked lower. In another embodiment, the video and audio components store and generate upon query predefined video, audio and/or image portions that correspond to a phrase, word, and/or image to automatically be generated based on the input having phrases, words and/or images that is received.

The classifying component 2008 is configured to store and communicate information about the user's preferences to the audio component 2002 and the video component 2004 in order to ensure searches for media content portions are generated according to classification criteria such as by audience categories according to demographic information, such as generation (e.g., gen X, baby boomers, etc.), race, ethnicity, interests, age, educational level, and the like. The user can decide or opt to search video/audio portions, for example, according to theme, genre, actor, awards of recognition, age, rating, religion, etc. according to user's taste and personality desired to be conveyed within the multimedia message generated, for example. The media content portions can then be viewed, previewed or manipulated further in a display 2012.

The media component 1620 further comprises and index component 2010 that can index media content portions generated that correspond to various phrases, words, gestures, and/or images according to various classifications discussed herein, such as actors, time periods, country of origin, languages, cultures, ratings, audience, etc. In one example, a server can provide a data store (e.g., the data store 1624), and/or data base with media content having edited movie clips, video clips, audio clips, image clips, etc., and/or content (e.g., audio, video and the like) in its entirety. In addition, a user can also provide from a data store or memory on a user device, computer device, mobile device and the like with a store of videos, songs, audio content (e.g., speeches, news clips, clips of events, etc.). The media content from any number of data stores external or internal can be analyzed and portioned according to the predetermined criteria discussed herein. The index component 2010, for example, can search according to natural language, imagery analysis, facial recognition, gesture recognition algorithms, etc. to edit and portion sets of media content portions and classify them according to the classification criteria for fast look up and retrieval.

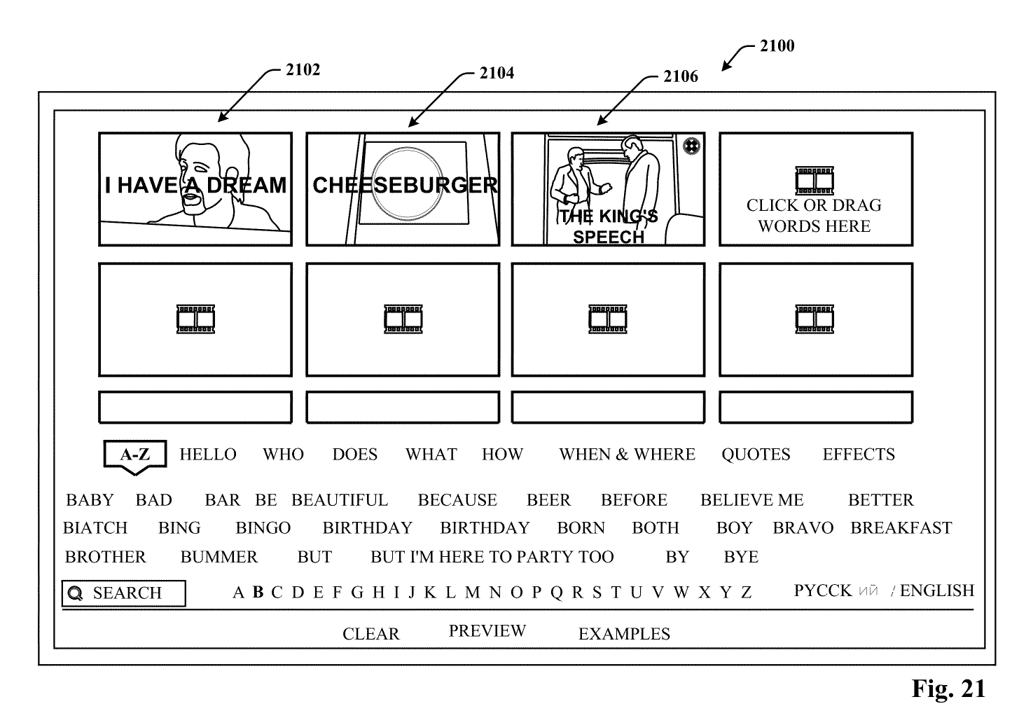

FIG. 21 illustrates one example of a view pane 2100 having predetermined text inputs that can be searched for and/or selected that have corresponding media content portions. Example view panes described herein are representative examples of aspects disclosed of one or more embodiments. These figures are illustrated for the purpose of providing examples of aspects discussed in this disclosure in viewing panes for ease of description. Different configurations of viewing panes are envisioned in this disclosure with various aspects disclosed. In addition, the viewing panes are illustrated as examples of embodiments and are not limited to any one particular configuration. The text inputs, for example, can be provided in a search component in order to find words or phrases with corresponding video portions. In addition or alternatively, for example, the text inputs could be words or phrases to search media content to correspond to the words or phrases according to a set of predetermined criteria, as discussed herein.

In one example of the view pane 2100, phrases, words and/or images can be dragged into the slide reel generated by the slide reel component 1721. The words or phrases can be classified according to classification criteria by the classifying component 2008 and/or an index component 2010, and further according to media content corresponding to the phrases, words, and/or images that meet a set of classification criteria, such as for popular videos (e.g., movies). The thumbnail component 1712 generates a display of a representation of each media content portion (e.g., video clips) with an indicator of the type of message the media content portion expresses. The words or phrases, and associated media content portions can be indexed by the media index component 2010. For example, a media content portion 2102 has the phrase “I HAVE A DREAM,” is expressed by a portion of the movie “You Don't Mess with the Zohan.” The thumbnail component is configured to generated metadata or information related to the media content portion when an input for example, such as a hovering input or else is sensed. For example, the media content portion 2106 displays metadata that the media content portion is derived from the movie “The Kings Speech,” in which the phrase “BEER” is spoken in a lucrative office setting. In addition, the media content portion 2104 includes “CHEESEBURGER” that is expressed by a portion or segment of the movie “Cloud with a Chance of Meatballs,” with a very deep machine voice.

Additionally, the viewing pane 2100 can include various classifications of various media content portions, such as alphabetical orderings, popular phrases, type of content or categories of words or phrases, quotes, effects and others, which can include sound effects, stage effects, video effects, dramatic actions, expressions, shouts, etc., which can be composed and transmitted via a mobile device or other device in a text message, multimedia message and/or other type messages.

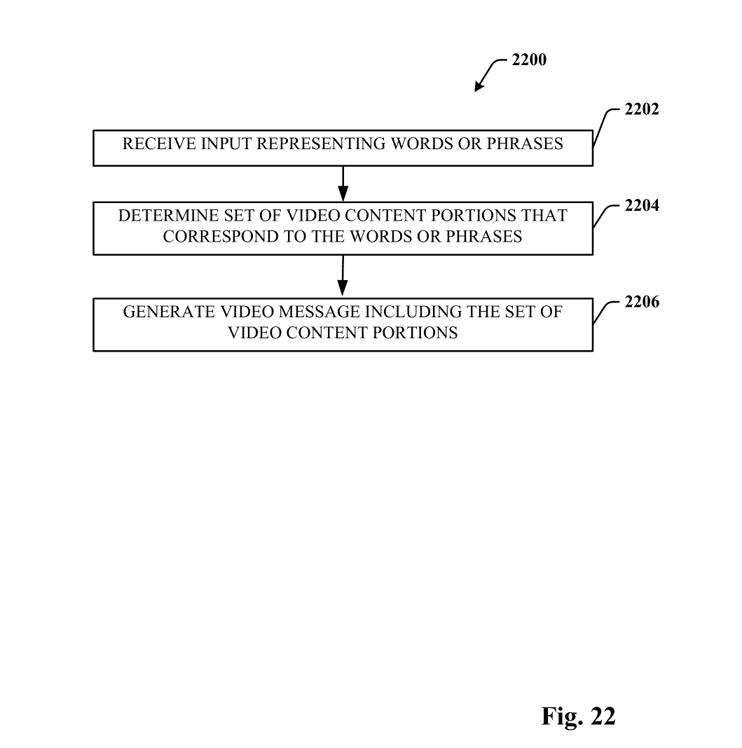

An example methodology 2200 for implementing a method for a messaging system is illustrated in FIG. 22 in accordance with aspects described herein. The method 2200, for example, provides for a system to interpret inputs received expressing a message via text, voice, selections, images, emoticons of one or more users and generating a corresponding message with media content portions for the portions, or segments of the inputs received. An output message can be generated based on the inputs received with a concatenation or sequence of media content portions of a group of different media content portions (e.g., video, audio, imagery and the like). Users are provided additional tools for self-expression by sharing and communicating message according to various taste, culture and personality.

At 2202, the method initiates with receiving, by a system including at least one processor, a set of text inputs that represent a set of words or phrases for a message. At 2204, a set of video content portions is determined that correspond to the set of words or phrases. The determining can occur according to a set of predetermined criteria. For example, the predetermined criteria can include a matching classification for the set of video content portions according to a set of predefined classifications (e.g., classification criteria), a matching action for the set video content portions with the set of words or phrases, and/or a matching audio clip within the set of video content portions that matches a word or phrase of the set of words or phrases.

At 2206 a video message is generated that includes the set of video content portions that correspond to the words or phrases. The message, for example, can be played as a video movie telegram or video based text message that contains the same audio or actions as that expressed in the input received. For example, the message can be generated as a video stream part that includes concatenated portions of different videos from the set of video content portions determined to correspond to the set of words or phrases, and a text part with text representing the set of words and phrases being configured to be displayed proximate to or overlaying the video stream part. The set of video content portions includes audio content portions that correspond to the set of words or phrases, or a set of actions that correspond to the set of words or phrases.

In another embodiment, the method 2200 can include classifying the set of video content portions according to a set of predefined classifications including at least one of a set of themes for the video content portions, a set of media ratings of the video content portions, a set of target age ranges for the video content portions, a set of voice tones of the video content portions, a set of extracted audio data from the video content portions, a set of actions or gestures included in the video content portions, or an alphabetical order of the set of video content portions.

In another embodiment, the method 2200 can include searching for the set of video content portions that correspond to the set of words or phrases in a networked data store, in a user data store on a mobile device, or from the networked data store and the user data store, and/or extracting a set of audio words and/or a set of images from videos to generate the set of video content portions that correspond to the set of words or phrases.

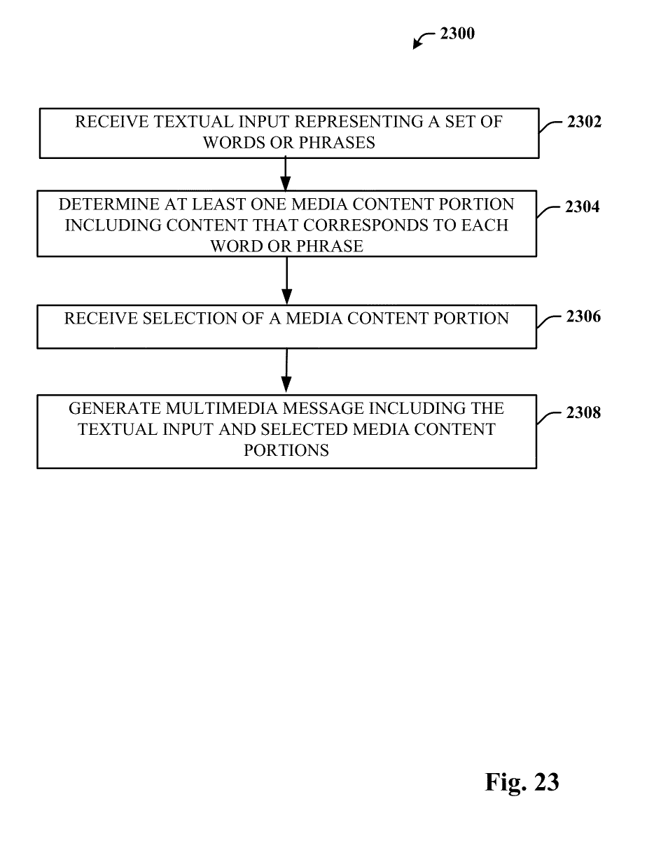

An example methodology 2300 for implementing a method for a system such as a recommendation system for media content is illustrated in FIG. 23. The method 2300, for example, provides for a system to evaluate various media content inputs and generate a sequence of media content portions that correspond to words, phrases or images of the inputs. At 2302, the method initiates with receiving a textual input representing a set of words or phrases of a message to be generated.

At 2302, at least one media content portion including content that corresponds to the word or phrase is determined. At 2306, a selection of a media content portion of the at least one media content portion is received. At 2308, a multimedia message is generated that includes the textual input and the selected media content portions respectively corresponding to the set of words or phrases. The multimedia message can include different portions of videos with audio content or image content

In another embodiment, the method 2300 includes displaying a set of thumbnail images of the selected media content portions in association with displaying respective words or phrases of the set of words or phrases that correspond to the selected media content portions. In addition or alternatively, a word or phrase of the set of words and phrases can be modified to a new word or phrase, and a selection can be received for a new media content portion from a group of media content portions corresponding to the new word or phrase to replace a media content portion associated with the word or phrase.

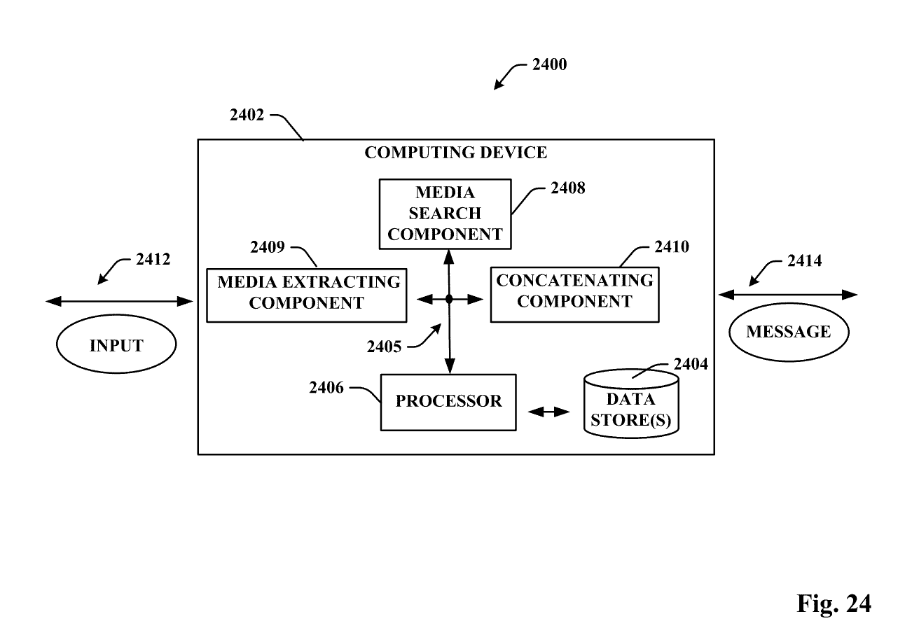

Referring to FIG. 24, illustrated is an example system 2400 that generates one or more messages having media content that corresponds to a set of text inputs in accordance with various aspects described herein. The one or messages generated can include a set of media content portions having one or more portions of video, audio and/or image content extracted from larger video and/or audio recordings. For example, in response to being viewed, a message generates a message that can comprise multiple portions of different videos (e.g., movies) of different video files, of different audio files, and/or of image files. Each of the portions, for example, can correspond to a word, phrase and/or gesture. The system 2400 is operable to create the message from the portions of media content that correspond to the words, phrases, and/or gestures of a set of inputs. The messages therefore can generate a video/audio stream that is a continuous media stream comprising, for example, multiple sound bites being played, multiple video segments being played, and/or multiple images being played from multiple different video, audio and/or images. For example, a video portion corresponding to one word is concatenated with a video portion corresponding to another word, and in response, the message plays two video portions in a sequence, in which each video portion plays a portion of a video or movie that corresponds to a word inputted to the system.

The system 2400 is operable as a networked messaging system that communicates multi-media messages, such as to a computing device, a mobile device, mobile phone, and the like. The system 2400, for example, includes a computing device 2402 that can comprise a personal computer device, a handheld device, a personal digital device (PDA), a mobile device (e.g., a mobile smart phone, laptop, etc.), a server, a host device, a client device, and/or any other computing device. The computing device 2402 comprises a memory 2404 for storing instructions that are executed via a processor 2406. The system 2400 can include other components (not shown), such as an input/output device, a power supply, a display and/or a touch screen interface panel. The system 2400 and the computing device 2402 can be configured in a number of other ways and can include other or different elements. For example, computer device 2402 may include one or more output devices, modulators, demodulators, encoders, and/or decoders for processing data.

The memory or data store(s) 2404 can include a random access memory (RAM) or another type of dynamic storage device that may store information and instructions for execution by the processor 2406, a read only memory (ROM) or another type of static storage device that can store static information and instructions for use by processing logic, a flash memory (e.g., an electrically erasable programmable read only memory (EEPROM)) device for storing information and instructions, and/or some other type of magnetic or optical recording medium and its corresponding drive.

A bus 2405 permits communication among the components of the system 2400. The processor 2406 includes processing logic that may include a microprocessor or application specific integrated circuit (ASIC), a field programmable gate array (FPGA), or the like. The processor 2406 may also include a graphical processor (not shown) for processing instructions, programs or data structures for displaying a graphic, such as a message generated by embodiments disclosed that comprises a continuous stream of video content portions and/or audio content portions, which include segments of a movie, song, speech, filmed event, each including video and/or audio. The message can therefore comprise one or more portions of video/audio content portions, in which each portion is a smaller segment of a larger video and/or audio that plays the smaller segment in a continuous sequence of one portion after the other portion within the message, and according to the order and association to a set of words and/or phrases received in a set of inputs 2412.

The set of inputs 2412 can be received via an input device (not shown) that can include one or more mechanisms in addition to touch panel that permit a user to input information to the computing device 2402, such as microphone, keypad, control buttons, a keyboard, a gesture-based device, an optical character recognition (OCR) based device, a joystick, a virtual keyboard, a speech-to-text engine, a mouse, a pen, voice recognition, a network communication module, etc.

The computing device 2402 includes a media search component 2408 that identifies a set of media content from one or more data stores 2404 based on a set of words or phrases. For example, a video and/or an audio such as a movie or song (e.g., “Streets of Fire,” U2—“Streets have no name”) can be identified by the search. In response to being identified, the media content can be tagged and indexed with metadata that further identifies and/or classifies the media content.

In one embodiment, the media search component 2408 is configured to search large volumes of memory storage and different data storages that can have multiple different types of libraries, files, applications, video content, audio content, etc., as well as to search data stores of third party servers, cloud resources, data stores of client devices, such as mobile devices. The media search component can identify video content (e.g., movies, home videos, video files, etc.) and/or audio content (e.g., movies, videos, video files, songs, audio books, audio files, etc.) from the data store(s) searched. The media search component 2408 can search for media content based on a set of predetermined criteria. For example, the media search component 2408 can search media content based on predefined classifications, such as use preferences that can includes, a theme, an artist, an actor or actress, a rating, a target audience, time period, author, and the like. The media search component 2408 is configured to search for the set of media content based on query terms, for example, that can be provided at a search input field or initiated by a graphical interface control by a user. Additionally or alternatively, the media content search component 2408 is configured to search data stores based on a set of words or phrases within the video content and/or audio content (e.g., a video file, audio file, etc.).

In another embodiment, the media search component 2408 is configured to identify video and/or audio content without receiving input, but only media content. In conjunction with an indexing component (discussed infra) the media search component only has to classify each media content (video content and audio content) and associate the content with an index of words and phrases contained within each media content file, for example.

In another embodiment, the media search component 2408 is configured to search a set of data stores for media content based on the set of inputs 2412 received by the compute device 2402. For example, the media search component 2408 is configured to dynamically search and identify content within a set of media content in a set of data stores that comprises and corresponds to a set of words or phrases of the set of inputs 2412. For example, in response to receiving the phrase, “I'll be coming for her, and I'll be coming for you too”, the media search component 2408 can identify the movie, “Streets of Fire” in the data store 2404 and outputs the particular media content (“Streets of Fire”) as a candidate for extraction to a media extracting component 2409.

The media extraction component 2409 is communicatively coupled to the media search component 2408, and receives media content that has been identified by the media search component 2408. The media extraction component 2409 is configured to extract portions of media content from a video, and/or an audio recording that can respectively comprise a plurality of words and/or phrases as part of the video, audio recording, and the like, so that when each portion is played a portion of the video, audio, etc., is played. Each portion, for example, includes scenes, and/or song portions that include the word and/or phrase of the set of inputs 2412 received. The media extraction component 2409 is configured to extract a set of media content portion from a set of media content based on the set of predetermined criteria, or a set of predetermined extraction criteria.

In one embodiment, the predetermined extraction criteria includes a matching of the words or phrases within the set of media content with the words and phrases of the set of inputs. Additionally or alternatively, the extraction can be a predetermined extraction according to words in a dictionary or other predefined words or phrases. The words, and/or phrases can be then indexed with the extracted portions of media that match the words and/or phrases. The media extraction component 2409 extracts the portions according to the set of predetermined criteria including a predefined location of where to cut, divide and/or segment a video recording, and/or audio recording (e.g., a video movie, song, speech, video/audio file, such as a .wav file and the like). The media extraction component 2409 can extract precise portions of media so that a multimedia message can be generated that includes a plurality of portions that each include movie scenes or song lines. The predetermined criteria can include a vague extraction, an estimated extraction or, in other words, an imprecise extraction so that words, phrases, and/or scenes surrounding the particular word and/or phrase of interest are also included within the portion extracted. This can provide further context of to the word or phrases, in which the portion extracted corresponds to or generate portions of video/audio on demand dynamically by providing a word or phrase via an input, such as a text, voice, selection, and/or other type input. The predetermined criteria can includes at least one of a classification of a set of classification and a matching of media content portions of the set of media content portions from the media content identified with a set of words or phrases. A matching audio clip or portion within the set of media content portions and/or a matching action to the words or phrases can also be part of the set of predetermined criteria by which the media extraction component 2409 extracts portions of video/audio content from media content files or recordings.

The computing device 2402 further includes a concatenating component 2410 that is configured to a concatenating component configured to assemble at least one media content portion of the set of media content portions into a multimedia message based on the set of inputs 2412 received for the multimedia message. The inputs 2412 can be a selection input of predefined words and/or phrases that correspond, or are correlated to the portions of media content extracted. In addition or alternatively, the inputs 2412 can include voice inputs, text inputs, and/or digital handwritten inputs with a touch screen or with a stylus. Thus the concatenation component 2410 generates a continuous stream of media content portions that make up a multimedia message. In response to the message being played, different portions of different video/audio content are played as a continuous video/audio, in which each of the portions include various scenes, musical notes, words, phrases, etc. that play a portion of the original and entire video and/or audio content from which they were extracted from. The concatenation component 2410 is configured to splice various portions together to form one continuous stream of video/audio that can then be sent as a message 2414 with each word or phrase corresponding to the set of inputs 2412 received by the system 2400.

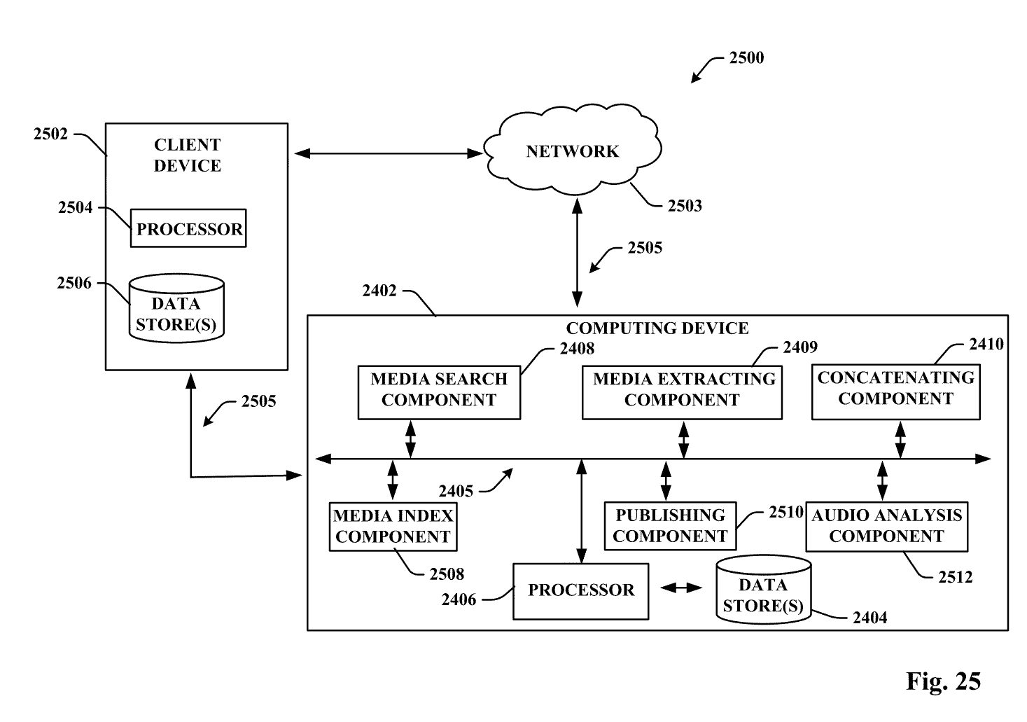

Referring now to FIG. 25, illustrated is a system 2500 that operates to extract media content portions from media content for generation of a multimedia message. The system 2500 includes the computing device 2402 that is communicatively coupled to a client device 2502 via a communication connection 2505 and/or a network 2503 for receiving input and communicating a multimedia message generated by the computing device 2402.

The client device 2502 can comprise a computing device, a mobile device and/or a mobile phone that is operable to communicate one or more message to other devices via an electronic digital message (e.g., a text message, a multimedia text message and the like). The client device 2502 includes a processor 2504 and at least one data store 2506 that processes and stores portions of media content such as video clips of a video comprising multiple video clips, portions of videos and/or portions of audio content and image content that is associated with the videos. The media content portions include portions of movies, songs, speeches, and/or any video and audio content segments that generate, recreate or play the portion of the media content that the media content portions are extracted from. The clips, portions or segments of media content can also be stored in an external data store, or any number of data stores such as a data store 2404 and/or data store 2506, in which the media content can include portions of songs, speeches, and/or portions of any audio content.

The client device 2402 is configured to communicate to other client devices (not shown) and to the computer device 2402 via the network 2503. The client device 2402, for example, can communicate a set of text inputs, such as typed text, audio or any other input that generates a digital typed message having alphabetic, numeric and/or alphanumeric symbols for a message. For example, the client device 2502 can communicate via a Short Message Service (SMS) that is a text messaging service component of phone, web, or mobile communication systems, using standardized communications protocols that allow the exchange of short text messages between fixed line and/or a wireless connection with a mobile device. The network 2503 can include a cellular network, a wide area network, local area network and other like networks, such as a cloud network that enables the delivery of computing and/or storage capacity as a service to a community of end-recipients.

The computing device 2402 includes the data store 2404, the processor 2406, the media search component 2408, the media extracting component 2409 and the concatenating component 2410 communicatively coupled via the communication bus 2405. The computing device 2402 further includes a media index component 2508, a publishing component 2510 and an audio analysis component 2512 for generating a multimedia message.

The media index component 2508 is configured to index media content portions of a set of media content portions according to a set of criteria. For example, the media index component 2508 can index the portions of media content according to words spoken, or phrases spoken within media content portions. For example, if the phrase “It is all good” is identified in a set of media content such as a video and/or an audio recording and extracted by the media extracting component 2409, then the media index component 2508 can store the portion of the media content with a tag or metadata that identifies the portion extracted as the phrase “It is all good.”

The media index component 2508 is configured to index a set of media content (e.g., videos and audio content) that are stored at the data store 2404 and/or the data store 2506, and store an index of media content portions within the data stores. In one embodiment, the media index component 2508 indexes the media content entirely based on a particular video or audio that is selected for extraction by the media extracting component 2409. Particular media content, such as particular movie, song, and the like, can indexed according to a classification criteria of the particular media content. For example, classification criteria can include a theme, genre, actor, actress, time period or date range, musician, author, rating, age range, voice tone, and the like. The computer device 2402 can receive media content from the client device 2502 for indexing by the media index component 2508, and/or index media content stored to predefine categories of media content and/or media content portions. In addition, the media index component 2508 is configured to index portions of media content that are extracted. The media indexing component 2508 can tag or associate metadata to each of the portions as well as the media content as a whole. The tag or metadata can includes any data related to the classification of the media content or portions related to the media content, as well as words, phrases or images pre-associated with the media content, which includes video, audio and/or video and audio pre-associated with one another in each portion extracted, for example.

The publishing component 2510 is configured to publish, via the network 2503 and/or a networked device or the client device 2502, the set of media content portions according to the indexing of the media content portions in an index of the data store 2404. The media content portions can be published irrespective of physical storage location, or, in other words, regardless of whether the portions are stored at the client device 2502, computing device 2402, and/or at the network 2503, for example, with words or phrases associated with respective media content portions of the set of media content portions, and/or published based on the metadata or a tag that the media content portions are indexed with. For example, a media content portion indexed according to the phrase “Put 'em up,” can be published as the phrase “Put 'em up” as well as each individual word or smaller phrase with a phrase, such as “put,” or “put 'em.” Additionally or alternatively, the media content portions can be published according to the classifications that the portions are indexed, such as the media content portion being extracted from a Western, as being spoken by the actor Clint Eastwood, being filmed during 1970's, being rated R, and/or other metadata or tag associated with the media content and/or the portions extracted from the media content.

In addition, the publishing component 2510 is configured to publish one or more of the computer executable components (e.g., the components of the computer device 2402) for download to the client device 2502, such as a mobile device via the network 2503. The publishing component 2510 of the computer device 2402 is configured to publish the components to a network for processing on the client device 2502, for example. In addition, the message generated by the computing device 2402 and/or the client device 2502 is published by the publishing component to a network for storage and/or communication to any other networked device. For example, a multimedia message generated by the computing device 2402 can include the media content portion with “Put 'em up” as audio content pre-associated with the video content portion extracted from a Clint Eastwood, as well as a concatenated portion thereto with video having pre-associated audio content of “I'll be comin for you,” as stated by the actor William Dafoe in the video “Streets of Fire.” The publishing component 2510 is operable to publish the multimedia message including the video portions and audio portions via the network 2503 for play as a single video and audio message joined together.

The audio analysis component 2512 is configured to analyze audio content of the set of media content and determine portions of the audio content that correspond to the set of words or phrases of the set of inputs. For example, the computing device 2402 is operable to receive a set of inputs corresponding to words or phrases for a message, and, based on a word or phrase in the set of inputs, the audio analysis component 2512 can analyze the media content for portions within media content having a matching word or phrase in the audio content of the media content. The media extracting component 2409 can receive then extract the portions with the matching word or phrase in the media content (e.g., video, and/or audio) to obtain a media content portion that has audio that includes the word or phrase. The media content portion, for example, can be a video segment with an actor saying the word or phrase, for example, as well as a song, speech, musical, etc.

The audio analysis component 2512, for example, can identify information meaning from audio signals for analysis, classification, storage, retrieval, synthesis, etc. In one embodiment, the audio analysis component 2512 recognizes words or phrases within a set of media content, such as by performing a sound analysis on the spectral content of the media content. Sound analysis, for example, can include the Fast Fourier Transform (FFT), Time-Based Fast Fourier Transform (TFFT) and/or the like tools. The audio analysis component 2512 is operable to produce audio files extracted from the media content, and analyze characteristics of the audio at any point in time, and/or as entire audio. The audio analysis component 2512 can then generate a graph over the duration of a portion of the audio content and/or the entire sequence of an audio recording that can be pre-associated with and/or not pre-associated with video or other media content. The media extracting component 2409 can thus extract portions of the media content based on the output of the audio analysis component 2512, such as part of the set of predetermined criteria upon which the extractions can be based.

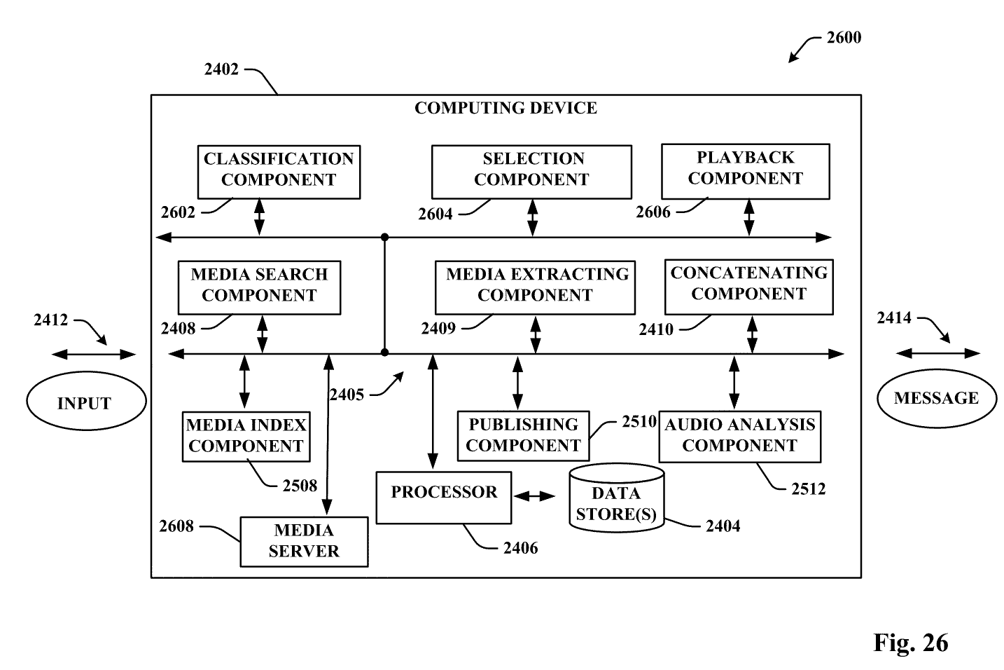

Referring now to FIG. 26, illustrated is a system 2600 in accordance with various embodiments described herein. The system 2600 comprises the computing device 2402. The computing device 2402 includes the data store 2404, the processor 2406, the media search component 2408, the media extracting component 2409, the concatenating component 2410, the media index component 2508, the publishing component 2510 and the audio analysis component 2512 communicatively coupled via the communication bus 2405. The computing device 2402 further includes a classification component 2602, a selection component 2604 and a playback component 2606 for generating a multimedia message.

The classification component 2602 is configured to classify the set of media content according to a set of classifications. For example, the classification of the set of media content can be based on a set of themes (e.g., spirituality, romance, autobiography, etc.), a set of media ratings (e.g. G, PG, R), a set of actors or actresses (e.g., John Wayne, Kate Hudson), a set of song artists (e.g., Bob Dylan), a set of titles, a set of date ranges and/or any other like identifying characteristic of media content. In one embodiment, the classification component 2602 communicates classification settings and/or data about the type of media content desired to the media extraction component 2409, which then extracts portions from the media content based on the set of classifications as well as the set of words or phrases received as input.

In another embodiment, the classification component classifies media content stored in the data store 2404 based on the set of classifications discussed above. Portions of the media content are extracted and can then be further classified according to additional criteria, such as voice tone, gender, race, emotion, age range, look and/or other characteristics of the video and/or audio, which could be suitable for a user to select when formulating a multimedia message 2414 with the computing device 2402. The classified portions of media content can be tagged or attributed with metadata that is associated with each portion within the data store 2404, as well as with the message 2414 before and after the message is communicated.

The selection component 2604 is configured to generate a set of predetermined selections such as selection options that include a set of textual words or phrases that correspond to at least one media content portion of the set of media content portions. The selection component 2604 is configured to receive the set of predetermined selections as the set of inputs and communicate the portions of media content corresponding to selections for generation of the multimedia message. For example, a selection can be a word or phrase such as “I love you.” Each word or the entire phrase can correspond to media content portions that make up “I love you”, thus generating a multimedia message that communicates “I love you.”

In addition or alternatively, the selections could be the portions of media content themselves, in which more than one media content portions corresponds to a given word or phrase. Consequently, various media content portions can generated by the selection component 2604 for a given word or phrase, in which selections can be received to associate a media content portion with any number of words or phrases. For example, if various media content portions for the word “love” are presented, a selection of the media content portion can be received and processed to associate the media content portion to the word “love” in the multimedia message. The multimedia message can then be generated to have various media content portions from different media content based on selections received, which are predetermined based on the word and/or selection options for various media content portions associated with a word or phrase. The selection component 2604 is configured to then communicate the media content portions as selections to be inserted into the multimedia message. The selections, for example, can be received via any number of graphical user interface controls, such as by drag and drop, links, drop down menus, and/or any other graphical user interface control.

A media server 2608 is configured to manage the various media content that is searched and indexed, as well as assist in publishing components of the computer device 2402 to a network for download on a mobile device or other device. The media server 2608 is thus configured to facilitate a sharing of media content of the set of data stores to communicate the respective media content portions of the media content via a network irrespective of physical storage location, and to manage storing of an index of different media content portions having video content and audio content based on associations to words or phrases including the set of words or phrases, and/or selections received at the selection component 2604.

The computing device 2402 further includes the playback component 2606 that is configured to generate a preview of the multimedia message including a rendering of selected media content portions of the set of media content portions in a concatenated video stream at a display component (not shown), such as a touch screen display or other display device. For example, in response to receiving a playback input, the playback component 2606 can provide a preview of the message generated with any number of media content portions that make up the phrase “I love you.” The message can then be further edited or modified to a user's satisfaction before sending based on a preview of the multimedia message.

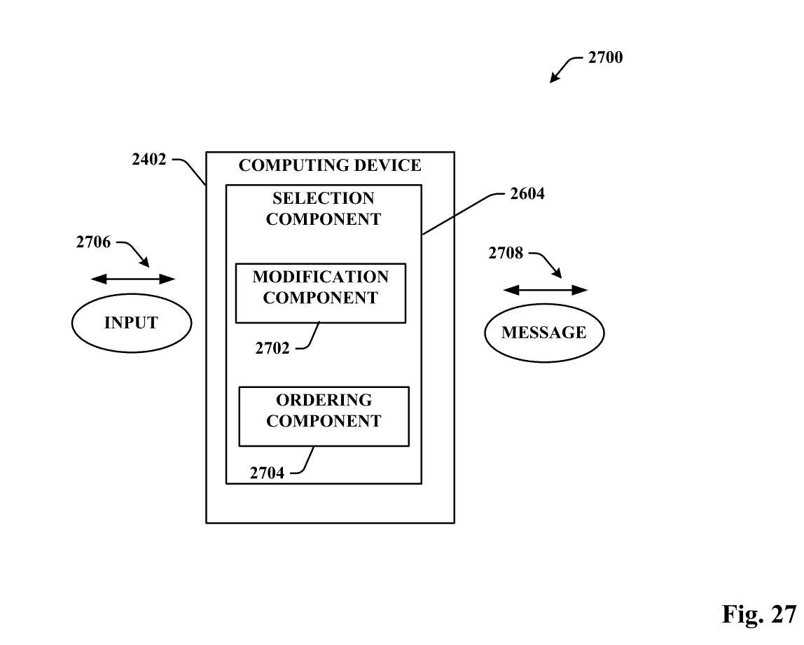

Referring to FIG. 27, illustrated is a system 2700 that generates messages with various forms of media content from a set of inputs, such as text, voice, and/or predetermined input selections that can be different or the same as the media content of the message in accordance with various embodiments herein. The system 2700 is configured to receive a set of inputs 2706 and communicate, transmit or output a message 2708. The set of inputs 2706 comprise a text message, a voice message, a predetermined selection and/or an image, such as a text-based image or other digital image, for example.

The selection component 2604 of the computing device 2402 further includes a modification component 2702 and an ordering component 2704. The modification component 2702 is configured to modify media content portions of the message 2708. The modification component 2702, for example, is operable to modify one or more media content portions such as a video clip and/or an audio clip of a set of media content portions that corresponds to a word or phrase of the set of words or phrases communicated via the input 2706. In one embodiment, the modification component 2702 can modify by replacement of the media content portions with a different media content portion to correspond with the word or phrase identified in the input 2706. For example, the message generated 2708 from the input 2706 can include media content portions, such as text phrases or words (e.g., overlaying or proximately located to each corresponding media content portion), video clips, images and/or audio content portions. The modification component 2702 is configured to modify the message 2708 with a new word or phrase to replace an existing word or phrase in the message, and, in turn, replace a corresponding video clip.

Additionally or alternatively, a video portion, audio portion, image portion and/or text portion can be replaced with a different or new video portion, audio portion image portion and/or text portion for the message to be changed, kept the same, or better expressed according to a user's defined preference or classification criteria. In addition or alternatively, the selection component 2604 can be provided a set of media content portions that correspond to a word, phrase and/or image of an input for generating the message 2708 and/or to be part of a group of media content portions corresponding with a particular word, phrase and/or image.

In another embodiment, the selection component 2604 is further configured to replace a media content portion that corresponds to the word or phrase with a different video content portion that corresponds to the word or phrase, and/or also replace, in a slide reel view, a media content portion that corresponds to the word or phrase with another media content portion that corresponds to another word or phrase of the set of words or phrases.

The selection component 2604 includes an ordering component 2704 that is configured to modify and/or determine a predefined order of the set of media content portions based on a received modification input for a modified predefined order, in which can be communicated with the set of words or phrases in the modified predefined order. For example, a message that is generated with media content portions to be played in multimedia message such as a video and/or audio message can be organized in a predefined order that is the order in which the input is provided or received by the message component 2410. The ordering component 2704 is thus configured to redefine the predefined order by either drop, drag, and/or some other ordering input that rearranges the media content portions.

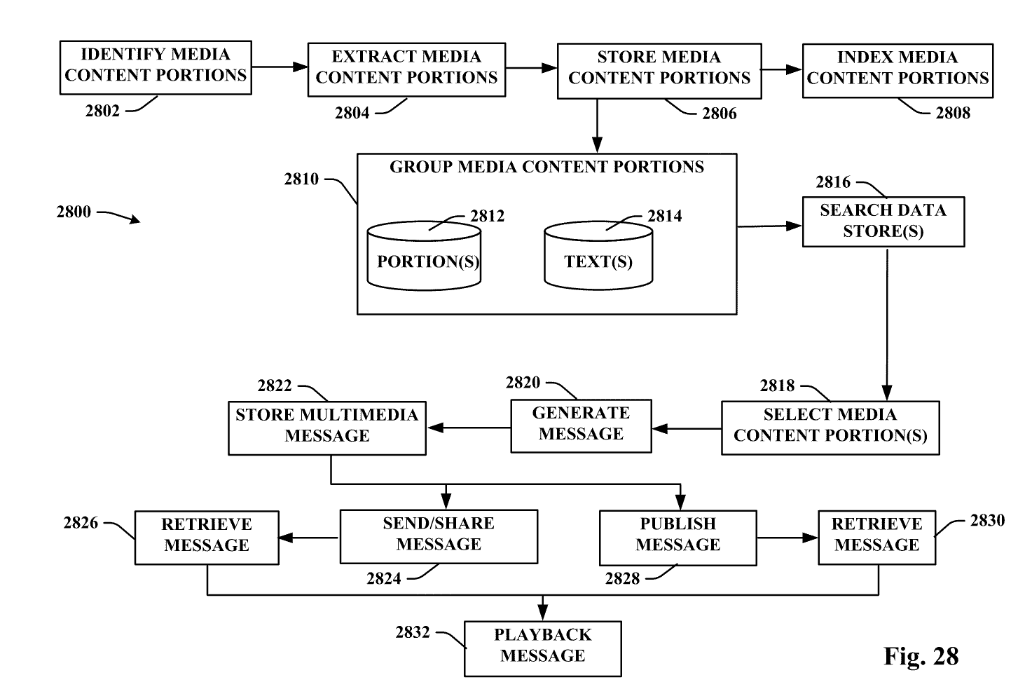

Referring to FIG. 28, illustrated is an exemplary system flow 2800 in accordance with embodiments described in this disclosure. The system 2800 identifies media content portions at 2802 based on a set of inputs, such voice inputs, digital typed inputs, text inputs and/or other inputs to generate a message with words or phrases, such as a selection of predefined words or phrases.

At 2804 media content portions of media content are extracted according to a set of predetermined criteria. For example, words or phrases of the text input can be associated with words and phrases of video and/or audio content and portions of media content corresponding to the words or phrases can be extracted. For example, the system is configured to edit, slice, portion and/or segment a video/audio for words, action scenes, voice tone, a rating of the video or movie, a targeted age, a movie theme, genre, gestures, participating actors and/or other classifications, in which the portion and/or segment is corresponded, associated and/or compared with the phrases or words of received inputs (e.g., text input). In addition or alternatively, the media content portions component 2804 is configured to dynamically, in real time generate corresponding video scenes, video/audio clips, portions and/or segments from an indexed set of videos stored in one or more data store(s).

At 2806, media content portions extracted are stored in one or more data store(s), such as a data store at a client device, a server, or a host device via network. At 2808 the media content portions are indexed. For example, a database index can be generated that is a data structure for improving the speed of media content retrieval operations on an index such as a database table. Indexes can be created with the media content portions, classifications, and corresponding words or phrases using one or more columns of a database table, providing the basis for both rapid random lookups and efficient access of ordered records.

At 2810, media content portions can be grouped and/or classified, for example, in a media portions database 2812 and/or words or phrases can be stored in a text data store 2814 that corresponds to each of the media portions. At 2816, data store(s) can be searched in response to a query for media content portions corresponding to the query terms. At 2818, a selection input is received that selects media content portion(s) generated from the query.

At 2820, a set of media content portions that correspond to the words or phrases of text according to a set of predetermined criteria and/or based on a set of user defined preferences/classifications is concatenated together to form a multimedia message. As stated above, text inputs can be selected, communicated and/or generated onsite via a web interface. The message can be dynamically generated as a multimedia message that corresponds to the words or phrases of the text message of the text input. The portions of media content can correspond to the words or phrases according to predefined criteria, for example, based on audio that matches each word or phrase of the text inputs, as well as classification criteria.

In one embodiment, the multimedia message can be generated to comprise a sequence of video/audio content portions from different videos and/or audio recordings that correspond to words or phrase of the input received (e.g., a text inputted message). The message can be generated to also display text within the message, similar to a text overlay or a subtitle that is proximate to or within the portion of the video corresponding to the word or phrase of the input. In the case of audio, the text message can also be generated along with the sound bites or audio segments (e.g., a song, speech, etc.) corresponding to the words or phrases of the text. The predetermined criteria, for example, can include a matching classification for the set of video content portions according to a set of predefined classifications, a matching action for the set video content portions with the set of words or phrases, or a matching audio clip (i.e., portion of audio content) within the set of video content portions that matches a word or phrase of the set of words or phrases. In addition, the matches or matching criteria of the predetermined criteria can be weighted, so that search results or generated results of corresponding media content portions are not exact. For example, a weighting of the predetermined criteria including a matching audio content for the set of video content portions can be weighted at only a certain percentage (e.g., 75%) so that the generated corresponding content generates a plurality of media content portions for a user to select from in building the message.

Further, the message of media content portions (e.g., portions of video and/or audio that are pre-associated with video to or not pre-associated) can be generated in response to the words or phrases of text according to a set of user pre-defined preferences/classifications (i.e., classification criteria). Classifying the set of media content portions (e.g., video/audio content portions) according to a set of predefined classifications includes classifying the media content portions according to a set of themes, a set of media ratings, a set of target age ranges, a set of voice tones, a set of extracted audio data, a set of actions or gestures (e.g., action scenes), an alphabetical order, gender, religion, race, culture or any number of classifications, such as demographic classifications including language, dialect, country and the like. In addition, the media content portions can be generated according to a favorite actor or a time period for a movie.

At 2822, the multimedia message that is generated can be shared, published and/or stored irrespective of location, such as on a client device, a host device, a network, and the like. At 2824 the message can be communicated or shared where the message is transmitted to a recipient, such as via a text multimedia message or other electronic means. At 2826, the message can be retrieved and played back at 2832 by a user and/or a recipient of the message. At 2828, message can also be published via a network, and retrieved at 2830 for playback at 2832 by any user of the system, and/or device having a network connection.

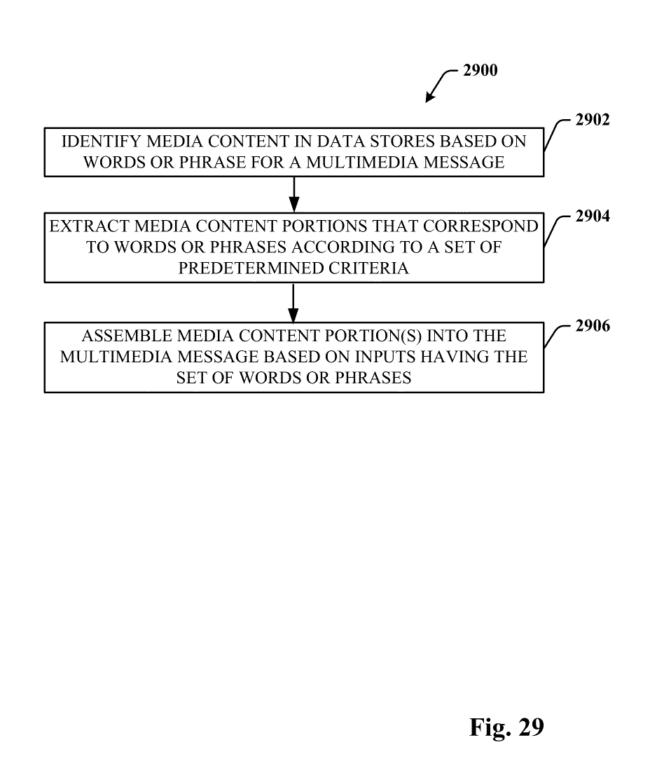

An example methodology 2900 for implementing a method for a messaging system is illustrated in FIG. 29 in accordance with aspects described herein. The method 2900, for example, provides for a system to interpret inputs received expressing a message via text, voice, selections, images, emoticons of one or more users and generating a corresponding message with media content portions for the portions, or segments of the inputs received. An output message can be generated based on the inputs received with a concatenation or sequence of media content portions of a group of different media content portions (e.g., video, audio, imagery and the like). Users are provided additional tools for self-expression by sharing and communicating message according to various taste, culture and personality.

At 2902, the method initiates with identifying, by a system including at least one processor, a set of media content such as video content and audio content in a set of data stores irrespective of location based on a set of words or phrases for a multimedia message.

At 2904, media content portions are extracted such as a set of video content portions and audio content portions, which correspond to the set of words or phrases according to a set of predetermined criteria. The predetermined criteria, for example, can be at least one classification of the set of classifications and a matching of media content portions of the set of media content portions from the set of media content with the set of words or phrases. The predetermined criteria can comprise a matching audio clip within the set of media content portions that matches a word or phrase of the set of words or phrases, one or more of a matching classification for the set of video content portions according to a set of predefined classifications, and/or a matching action for the set video content portions with the set of words or phrases.

At 2906, the method 2900 continues with assembling at least one video content portion and at least one audio content portion of the set of media content portions into the multimedia message based on a set of inputs having the set of words or phrases. For example, the order that the inputs are received can be the order in which the multimedia message is generated as well as matching words or phrases from the set of inputs.

In one embodiment, the method 2900 includes dividing the set of video content and audio content into video content portions and audio content portions according to at least one of words, phrases, or images determined to be included in the video content portions or the audio content portions. For example, entire video and audio content can be divided into words, phrases and/or images for selection of various media content portions to be inserted into the message. In addition, a number of classification criteria can also be accounted for in the dividing, which enables predefined portions to be indexed and further selected for one or more multimedia messages.

In another embodiment, the method can classify media content portions according to a set of predefined classifications that includes at least one of a set of themes, a set of song artists, a set of actors, a set of album titles, a set of media ratings of the set of video content and audio content, voice tone, or a set of time periods.

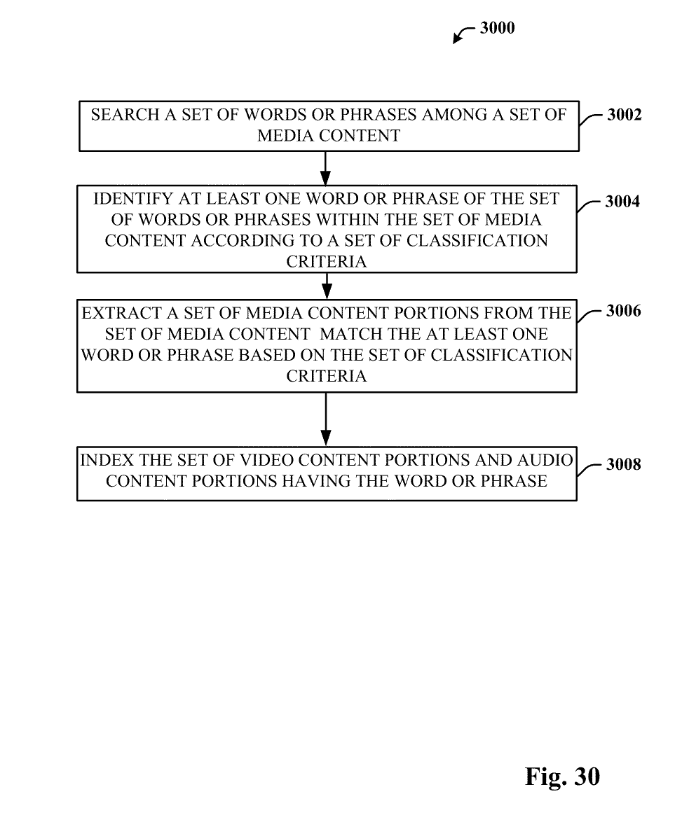

An example methodology 3000 for implementing a method for a system such as a multimedia system for media content is illustrated in FIG. 30. The method 3000, for example, provides for a system to evaluate various media content inputs and generate a sequence of media content portions that correspond to words, phrases or images of the inputs. At 3002, the method initiates with searching for a set of words or phrases among a set of media content such as video content and audio content in a set of data stores.

At 3004, at least one word or phrase of the set of words or phrases are identified within the set of media content searched according to a set of classification criteria. The classification criteria can be, for example, an actor, an actress, a theme, a genre, a rating of a film, a target audience, a date range or time period, and/or the like.

At 3006, a set of media content portions are extracted having audio content that matches the word or phrase based on the set of classification criteria. At 3008, the set of media content portions are indexed having the at least one word or phrase of the set of words or phrases that are pre-associated with video content and audio content in the set of data stores according to at least one of the at least one word or phrase, or the classification criteria.

The method can further include concatenating at least two video content portions or audio content portions of the set of video content portions and audio content portions into the multimedia message based on a set of selection inputs, and communicating the set of video content portions and audio content portions as selections to be inserted into the multimedia message.

### Exemplary Networked and Distributed Environments

One of ordinary skill in the art can appreciate that the various non-limiting embodiments of the shared systems and methods described herein can be implemented in connection with any computer or other client or server device, which can be deployed as part of a computer network or in a distributed computing environment, and can be connected to any kind of data store. In this regard, the various non-limiting embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the shared shopping mechanisms as described for various non-limiting embodiments of the subject disclosure.

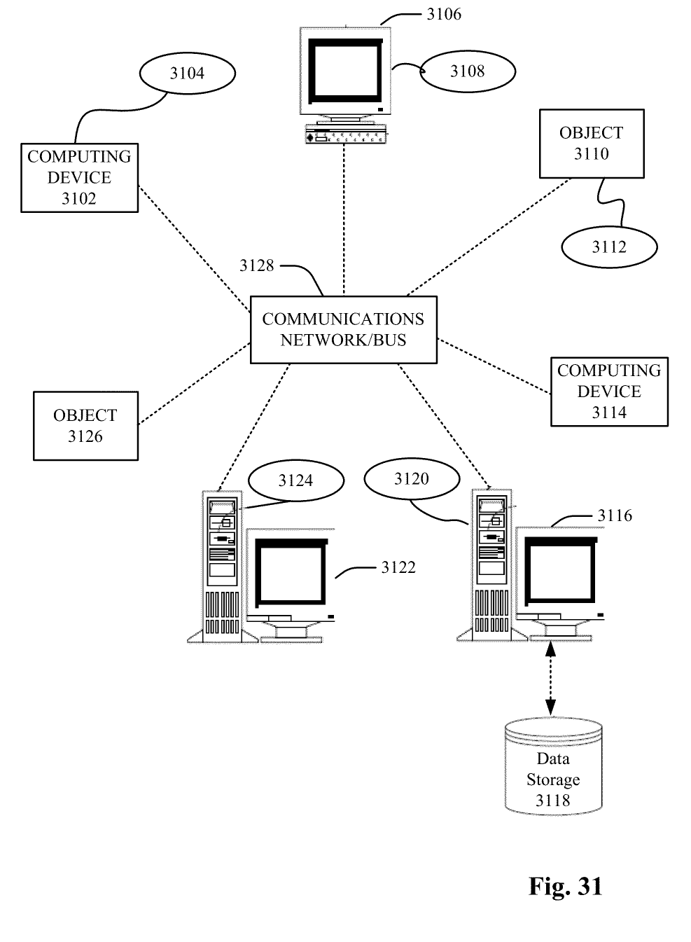

FIG. 31 provides a schematic diagram of an exemplary networked or distributed computing environment. The distributed computing environment comprises computing objects 3110, 3112, etc. and computing objects or devices 3120, 3122, 3124, 3126, 3128, etc., which may include programs, methods, data stores, programmable logic, etc., as represented by applications 3130, 3132, 3134, 3136, 3138. It can be appreciated that computing objects 3110, 3112, etc. and computing objects or devices 3120, 3122, 3124, 3126, 3128, etc. may comprise different devices, such as personal digital assistants (PDAs), audio/video devices, mobile phones, MP3 players, personal computers, laptops, etc.

Each computing object 3110, 3112, etc. and computing objects or devices 3120, 3122, 3124, 3126, 3128, etc. can communicate with one or more other computing objects 3110, 3112, etc. and computing objects or devices 3120, 3122, 3124, 3126, 3128, etc. by way of the communications network 3140, either directly or indirectly. Even though illustrated as a single element in FIG. 31, communications network 3140 may comprise other computing objects and computing devices that provide services to the system of FIG. 31, and/or may represent multiple interconnected networks, which are not shown. Each computing object 3110, 3112, etc. or computing object or device 3120, 3122, 3124, 3126, 3128, etc. can also contain an application, such as applications 3130, 3132, 3134, 3136, 3138, that might make use of an API, or other object, software, firmware and/or hardware, suitable for communication with or implementation of the shared shopping systems provided in accordance with various non-limiting embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the shared shopping systems as described in various non-limiting embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In client/server architecture, particularly a networked system, a client is usually a computer that accesses shared network resources provided by another computer, e.g., a server. In the illustration of FIG. 31, as a non-limiting example, computing objects or devices 3120, 3122, 3124, 3126, 3128, etc. can be thought of as clients and computing objects 3110, 3112, etc. can be thought of as servers where computing objects 3110, 3112, etc., acting as servers provide data services, such as receiving data from client computing objects or devices 3120, 3122, 3124, 3126, 3128, etc., storing of data, processing of data, transmitting data to client computing objects or devices 3120, 3122, 3124, 3126, 3128, etc., although any computer can be considered a client, a server, or both, depending on the circumstances. Any of these computing devices may be processing data, or requesting services or tasks that may implicate the shared shopping techniques as described herein for one or more non-limiting embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 3140 or bus is the Internet, for example, the computing objects 3110, 3112, etc. can be Web servers with which other computing objects or devices 3120, 3122, 3124, 3126, 3128, etc. communicate via any of a number of known protocols, such as the hypertext transfer protocol (HTTP). Computing objects 3110, 3112, etc. acting as servers may also serve as clients, e.g., computing objects or devices 3120, 3122, 3124, 3126, 3128, etc., as may be characteristic of a distributed computing environment.

### Exemplary Computing Device

As mentioned, advantageously, the techniques described herein can be applied to a number of various devices for employing the techniques and methods described herein. It is to be understood, therefore, that handheld, portable and other computing devices and computing objects of all kinds are contemplated for use in connection with the various non-limiting embodiments, i.e., anywhere that a device may wish to engage on behalf of a user or set of users. Accordingly, the below general purpose remote computer described below is but one example of a computing device.

Although not required, non-limiting embodiments can partly be implemented via an operating system, for use by a developer of services for a device or object, and/or included within application software that operates to perform one or more functional aspects of the various non-limiting embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is to be considered limiting.

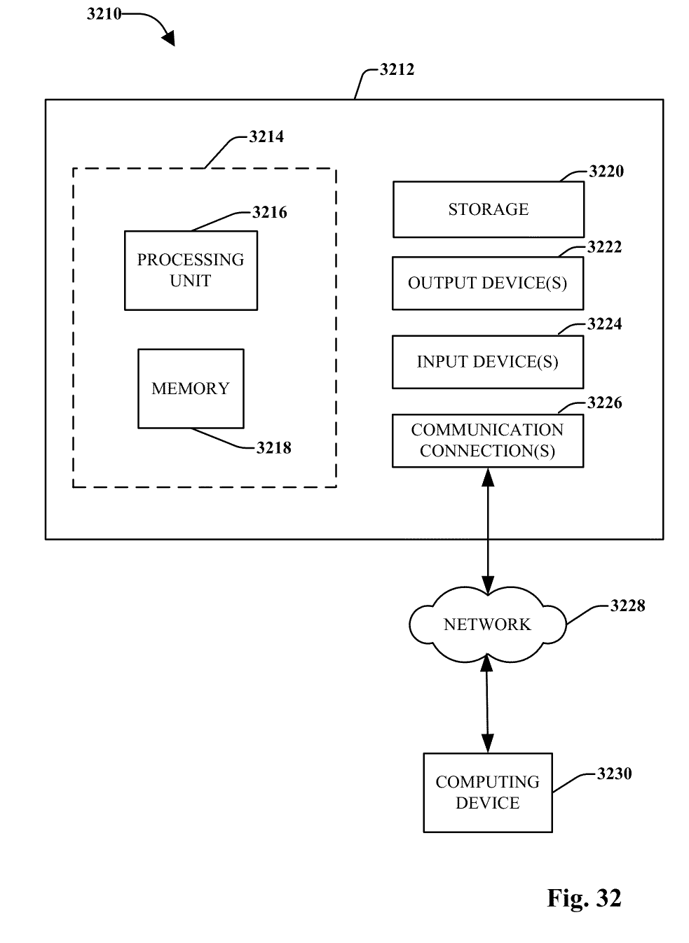

FIG. 32 and the following discussion provide a brief, general description of a suitable computing environment to implement embodiments of one or more of the provisions set forth herein. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 32 illustrates an example of a system 3210 comprising a computing device 3212 configured to implement one or more embodiments provided herein. In one configuration, computing device 3212 includes at least one processing unit 3216 and memory 3218. Depending on the exact configuration and type of computing device, memory 3218 may be volatile (such as RAM, for example), non-volatile (such as ROM, flash memory, etc., for example) or some combination of the two. This configuration is illustrated in FIG. 32 by dashed line 3214.

In other embodiments, device 3212 may include additional features and/or functionality. For example, device 3212 may also include additional storage (e.g., removable and/or non-removable) including, but not limited to, magnetic storage, optical storage, and the like. Such additional storage is illustrated in FIG. 32 by storage 3220. In one embodiment, computer readable instructions to implement one or more embodiments provided herein may be in storage 3220. Storage 3220 may also store other computer readable instructions to implement an operating system, an application program, and the like. Computer readable instructions may be loaded in memory 3218 for execution by processing unit 3216, for example.

The term “computer readable media” as used herein includes computer storage media. Computer storage media includes volatile and nonvolatile, removable and non-removable media implemented in any method or technology for storage of information such as computer readable instructions or other data. Memory 3218 and storage 3220 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 3212. Any such computer storage media may be part of device 3210.

Device 3212 may also include communication connection(s) 3226 that allows device 3210 to communicate with other devices. Communication connection(s) 3226 may include, but is not limited to, a modem, a Network Interface Card (NIC), an integrated network interface, a radio frequency transmitter/receiver, an infrared port, a USB connection, or other interfaces for connecting computing device 3212 to other computing devices. Communication connection(s) 3226 may include a wired connection or a wireless connection. Communication connection(s) 3226 may transmit and/or receive communication media.

The term “computer readable media” as used herein includes computer readable storage media and communication media. Computer readable storage media includes volatile and nonvolatile, tangible, removable and non-removable media implemented in any method or technology for storage of information such as computer readable instructions or other data. Memory 3218 and storage 3220 are examples of computer readable storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 3210. Any such computer readable storage media may be part of device 3212.

Device 3212 may also include communication connection(s) 3226 that allows device 3212 to communicate with other devices. Communication connection(s) 3226 may include, but is not limited to, a modem, a Network Interface Card (NIC), an integrated network interface, a radio frequency transmitter/receiver, an infrared port, a USB connection, or other interfaces for connecting computing device 3212 to other computing devices. Communication connection(s) 3226 may include a wired connection or a wireless connection. Communication connection(s) 3226 may transmit and/or receive communication media.

The term “computer readable media” may also include communication media. Communication media typically embodies computer readable instructions or other data that may be communicated in a “modulated data signal” such as a carrier wave or other transport mechanism and includes any information delivery media. The term “modulated data signal” may include a signal that has one or more of its characteristics set or changed in such a manner as to encode information in the signal.

Device 3212 may include input device(s) 3224 such as keyboard, mouse, pen, voice input device, touch input device, infrared cameras, video input devices, and/or any other input device. Output device(s) 3222 such as one or more displays, speakers, printers, and/or any other output device may also be included in device 3212. Input device(s) 3224 and output device(s) 3222 may be connected to device 3212 via a wired connection, wireless connection, or any combination thereof. In one embodiment, an input device or an output device from another computing device may be used as input device(s) 3224 or output device(s) 3222 for computing device 3212.

Components of computing device 3212 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 3212 may be interconnected by a network. For example, memory 3218 may be comprised of multiple physical memory units located in different physical locations interconnected by a network.

Those skilled in the art will realize that storage devices utilized to store computer readable instructions may be distributed across a network. For example, a computing device 3230 accessible via network 3228 may store computer readable instructions to implement one or more embodiments provided herein. Computing device 3212 may access computing device 3230 and download a part or all of the computer readable instructions for execution. Alternatively, computing device 3212 may download pieces of the computer readable instructions, as needed, or some instructions may be executed at computing device 3212 and some at computing device 3230.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

1. A system, comprising:
a memory that stores computer-executable components; and
a processor, communicatively coupled to the memory, that facilitates execution of the computer-executable components, the computer-executable components including:
a text component configured to receive a text message having an emoticon or an acronym for generation of a multimedia message;
an image analysis component configured to identify the emoticon or the acronym in the text message;
a media splicing component configured to extract a set of media content portions from media content that correspond to the emoticon or the acronym; and
a message component configured to generate the multimedia message with the set of media content portions.

2. The system of claim 1, wherein the text message includes an emoticon and an acronym, and the media splicing component is configured to extract the set of media content portions from the media content that correspond to the emoticon and the acronym.

3. The system of claim 2, wherein the image analysis component is further configured to determine images in the media content that correspond to the emoticon or the acronym of the text message.

4. The system of claim 3, wherein the media splicing component is further configured to extract the set of media content portions from the media content according to a set of predetermined criteria including at least one of a matching of audio content of the media content with words that are represented by the acronym or the matching of an action, an expression, or audio content with an image or an emotion represented by the emoticon.

5. The system of claim 4, wherein the media content includes a set of video content and a set of audio content that corresponds to the video content.

6. The system of claim 1, the computer-executable components further comprising:
an acronym correlation component configured to identify words represented by the acronym of the text message.

7. The system of claim 1, the computer-executable components further comprising:
an emoticon component configured to identify an image or a sound represented by the emoticon of the text message.

8. The system of claim 1, wherein the message component is further configured to generate the multimedia message with the set of media content portions that correspond to the emoticon or the acronym of the set of text messages according to a set of classifications.

9. The system of claim 8, a classification component configured to receive a set of classification options for the set of classifications, wherein the set of classifications include at least one of a set of themes selected to correspond with the set of media content, a set of song artists selected to correspond with the set of media content, a set of actors selected to correspond with the set of media content, a set of album titles selected to correspond with the set of media content, a set of media ratings of the set of media content, a voice tone selected to correspond with the set of media content, a time period selected to correspond with the set of media content or a personal media content preference selected to correspond with the set of media content from a personal video or audio stored in a data store.

10. The system of claim 8, wherein the set of media content includes at least one of video content having audio content, video content, audio content, or an image, from cinematic movie content that includes a film featured in a public theatre.

11. The system of claim 8, wherein the set of media content includes at least one of video content having audio content, video content, audio content, or an image, from a set of personal media content captured from an image capturing device and stored in the memory.

12. A method, comprising:
receiving, by a system including at least one processor, a text message having an emoticon or an acronym for generation of a multimedia message;
identifying the emoticon or the acronym in the text message with an image or a set of words represented by the emoticon or the acronym;
extracting a set of media content portions from media content that correspond to the emoticon or the acronym according to a first set of predetermined criteria; and
generating the multimedia message with the set of media content portions.

13. The method of claim 12, wherein the extracting the set of media content portions based on a set of predetermined criteria that includes at least one of a match of the image represented by the emoticon with an action, an expression, or audio content associated with the image or a match of the set of words with audio content associated with the media content.

14. The method of claim 13, wherein the first set of predetermined criteria includes at least one of audio content corresponding to the set of images, scenes of video in the set of media content corresponding to the set of images, facial expressions corresponding to the set of images, a matching of a first emotion associated with the emoticon or acronym with a second emotion expressed or portrayed in the set of media content, or a matching of an acronym with a word or phrase corresponding to a set of video images or a set of audio content in the media content.

15. The method of claim 12, wherein the generating of the multimedia message with the set of media content portions includes generating the multimedia message with the set of media content portions according to a second set of predetermined criteria that includes at least one of a genre, a time period, an actor or actress, a singer, a voice tone, or a rating of the set of media content that the set of media content portions are generated from.

16. The method of claim 15, further comprising:
corresponding a set of images corresponding to the emoticon or the acronym with the set of media content portions based on at least one of a set of facial expressions, a set of actions, a set of sounds, or a set of characteristics, identified in the set of media content portions that relate to the emoticon or the acronym and the second set of predetermined criteria.

17. The method of claim 16, wherein the generating of the multimedia message includes generating the multimedia message with media content portions of the set of media content portions that include the set of images.

18. The method of claim 12, further comprising:
determining an image from the set of media content portions corresponding to the emoticon or the acronym from the text message that includes video content, audio content, or the video content and the audio content from the set of media content portions.

19. The method of claim 18, further comprising:
editing the image that corresponds to the emoticon or the acronym received for generation of the multimedia message, wherein the emoticon or the acronym includes a text based image or text based acronym.

20. The method of claim 18, further comprising:
associating the acronym received in the text message with at least one media content portion based on a matching of the acronym with a word or phrase and at least one video content portion having audio content corresponding to the word or phrase.

21. The method of claim 12, further comprising:
identifying an emotion represented by the emoticon or acronym from the text message; and
determining the set of media content portions of the set of media content that match the emotion.

22. The method of claim 20, further comprising:
presenting in a display of the set of media content portions that match the emotion; and
receiving a media content selection for the set of media content portions that match the emotion and associating the set of media content portions with the emotion.

23. The method of claim 20, wherein the identifying the emotion includes identifying the emotion with a text based image.

24. An apparatus comprising:
a memory storing computer-executable instructions; and
a processor, communicatively coupled to the memory, that facilitates execution of the computer-executable instructions to at least:
receive an emoticon or an acronym in a set of text messages for generation of a multimedia message;
identify a set of media content portions from video content based on the emoticon or the acronym; and
generate the multimedia message with the set of media content portions having at least one video image or audio content corresponding to the emoticon or the acronym.

25. The apparatus of claim 24, wherein the set of media content portions are identified from the set of media content according to a set of predetermined criteria including the set of media content portions having a match with a set of characteristics of the set of emoticons or acronyms, or the set of media content portions satisfying a set of classification criteria selected by at least one selection input.

26. The apparatus of claim 25, wherein the set of characteristics include an emotion of the emoticon or audio content that corresponds to the acronym.

27. The apparatus of claim 26, wherein the set of classification criteria include at least one of a genre, a time period, an actor or actress, a singer, a voice tone, or a rating of the set of media content that the set of media content portions are generated from based on a set of selection options corresponding to each classification criteria selected as the set of classification criteria.

28. The apparatus of claim 24, wherein the processor further facilitates execution of the computer-executable instructions to:
generate the multimedia message with the set of media content portions that correspond to at least one emoticon of the set of emoticons or acronyms from the set of text messages.

29. The apparatus of claim 28, wherein the processor further facilitates execution of the computer-executable instructions to:
generate the multimedia message with the set of media content portions that correspond to at least one audio content of the emoticon and the acronym received in the text message.

30. The apparatus of claim 24, wherein the processor further facilitates execution of the computer-executable instructions to:
reconfigure a correlation between the emoticons or the acronym with the set of media content portions.

31. A tangible computer readable storage medium comprising computer executable instructions that, in response to execution, cause a computing system including at least one processor to perform operations, comprising:
receiving an emoticon or an acronym for generating a multimedia message;
for the emoticon or the acronym,
determining a set of media content portions that corresponds to the emoticon or the acronym based on a set of predetermined criteria; and
generating the multimedia message with the set of media content portions that correspond to the received emoticon or the received acronym.

32. The tangible computer readable storage medium of claim 31, the operations further including:
receiving the emoticon or the acronym from at least one of a predefined selection input, a text message, or a query term.

33. The tangible computer readable storage medium of claim 31, the operations further including:
generating the multimedia message including video content and audio content that corresponds to the emoticons or the acronym.

34. The tangible computer readable storage medium of claim 31, wherein the set of predetermined criteria includes at least on selection option of a set of classification criteria, a matching emotion of the emoticon with at least one image of the set of media content portions, a matching audio content of an emotion with the emoticon or the acronym, a matching audio content of the acronym, or a matching action in a video portion of the emoticons or the acronym.

35. A system comprising:
means for receiving a set of message inputs having at least one of an emoticon or an acronym for a multimedia message;
means for identifying a set of media content portions of a set of media content that correspond to the emoticon or the acronym; and
means for generating the multimedia message with the set of media content portions that correspond to the emoticon or the acronym.

36. The system of claim 35, wherein the set of message inputs comprise a text message with the emoticon or the acronym to which the media content portions of the multimedia message correspond, wherein the text message includes a set of words or phrases.

37. The system of claim 36, further comprising:
means for editing the emoticon or the acronym that is correlated with the set of media content portions.

38. The system of claim 36, wherein the multimedia message includes media content portions of the set of media content portions that correspond to one more words or phrases of the set of words or phrases of the text message.
